(19) United States
(12) Patent Application Publication
(10) Pub. No.: US 2007/0229204 A1
(43) Pub. Date: Oct. 4, 2007

(54) MICRO-MECHANICAL MODULATING ELEMENT, MICRO-MECHANICAL MODULATING ELEMENT ARRAY, IMAGE FORMING APPARATUS, AND METHOD OF DESIGNING A MICRO-MECHANICAL MODULATING ELEMENT

(75) Inventors: Shinya OGIKUBO, Ashigarakami-gun (JP); Koichi Kimura, Saitama-shi (JP); Fumihiko Mochizuki, Ashigarakami-gun (JP); Hirochika Nakamura, Ashigarakami-gun (JP)

Correspondence Address: SUGHRUE-265550, 2100 PENNSYLVANIA AVE. NW, WASHINGTON, DC, 20037-3213, US

(73) Assignee: FUJIFILM Corporation, Minato-ku (JP)

(21) Appl. No.: 11/696,471

(22) Filed: Apr. 4, 2007

(30) Foreign Application Priority Data
Apr. 4, 2006 (JP) P2006-103359

(51) Int. Cl. H01F 7/08

(52) U.S. Cl. 335/220

(57) ABSTRACT

A micro-electromechanical modulating element including a plurality of movable portions as defined herein and a plurality of driving portions as defined herein, wherein a dynamic pull-in voltage defined herein is set to be lower than a hold voltage defined herein, and the driving portion drives the movable portion by a drive voltage greater than or equal to the hold voltage and the drive voltage is less than or equal to 10 V.

### FIELD OF THE INVENTION

The present invention relates to a micro-electromechanical modulating element (in particular, the structure of a micro-electromechanical modulating element of a rotating system which is driveable at a low voltage and rotates bidirectionally, as well as dynamic analysis and condition setting, including a viscous effect, for driving the modulating element at a low voltage), a micro-electromechanical modulating element array, an image forming apparatus, and a method of designing a micro-electromechanical modulating element.

### BACKGROUND OF THE INVENTION

In recent years, due to the rapid progress of an MEMS technology (MEMS: Micro-Electromechanical Systems), development of micro-electromechanical modulating elements for electrically displacing and moving a micro-mechanical element of μm order has been actively carried out. Among the micro-electromechanical modulating elements, for example, a digital micromirror device (DMD) manufactured by Texas Instruments Incorporated and capable of deflecting light by tilting a micromirror is known (refer to JP-A-2002-189178 (corresponding to US2002/0109903A1)). This is a device in which a movable portion is rotationally displaced as an electrostatic force is caused to act in another direction in the movable portion tilted in one direction by an electrostatic force, so as to effect the modulation of light in a mirror portion provided in the movable portion. The DMD is used in wide applications in the field of optical information processing, such as a projecting display, a video monitor, a graphic monitor, a television set, electrophotographic printing, and the like. Further, in optical switches, expectations are placed on the application to optical communication, optical interconnection (a signal connection technology using light, such as an interconnecting network in a parallel computer), optical information processing (information processing by optical computing), and the like.

The DMD has a structure in which the movable portion is rotationally displaceably supported by an elastically supporting portion, and the movable portion is driven as a predetermined drive voltage is applied to a driving portion.

The drive voltage under the present circumstances is, for example, 20 V to 30 V or thereabouts and is a fairly high voltage. However, it is projected that, in the future, the pixel size will be diminished for improvement of the degree of integration, and that a demand for a low-voltage drive will increase.

### SUMMARY OF THE INVENTION

Because the transition time of the movable portion of the DMD (a time period from a state in which the movable portion is tilted on one side until the movable portion is tilted on the other side) or the response speed thereof (a speed at a time when the movable portion in the state of being tilted on one side is tilted toward the other side) is determined by a balance among the moment of inertia due to the structure of the movable portion, an elastic force of a supporting portion for supporting the movable portion, and the magnitude of a voltage to be applied, it has hitherto been possible to allow appropriate operation to be carried out if that balance is optimized within the scope of the conventional art.

However, in a case where the drive voltage is made extremely low, the behavioral analysis itself of the element can be performed to some extent by an extension of a conventional design approach, but the effect of viscosity in a micro region may conceivably increase more than before. Under the present situation, knowledge for taking this effect of viscosity into consideration is insufficient, and the precise behavior of the element at a low drive voltage has not yet been fully analyzed, so that it is difficult to cope with the case by resorting to a conventional design approach. For example, if the drive voltage is low, the attracting force due to the electrostatic force becomes small, so that cases can occur in which the movable portion cannot be pulled in to a final displacement position (normal stop position). Also, cases can be assumed in which even if the movable portion could be pulled in, the movable portion cannot be maintained in a state of being at a standstill at the final displacement position, and the movable portion is ultimately restored to its original state.

In conventional cases where the movable portion is driven at such a high voltage as more than 20 V, in the dynamic behavioral analysis of the process in which the movable portion moves, particular attention may not be paid to the viscosity of ambient air. However, in cases where a low-voltage drive is carried out, the effect of this viscosity becomes rather important and needs to be sufficiently analyzed in advance including the process of the movable portion in action, so as to be made use of in an appropriate structural design. Nevertheless, the dynamic analysis which takes the effect of viscosity into consideration has been such that it can be said to be a substantially uncharted area.

The invention has been devised in view of the above-described consideration, and its object is to analyze the relationship between the size of the movable portion of the micro-electromechanical modulating element of a rotating system and the elastic force of the elastically supporting portion, including the effect of viscosity due to the ambient air, so as to clarify the dynamic behavior of the movable portion, and to realize, on the basis of its knowledge, a structure whereby the movable portion can be appropriately displaced and held at a final displacement position at a low voltage (e.g., 10 V or less).

The above object in accordance with the invention can be attained by the following configurations:
(1) A micro-electromechanical modulating element comprising: a plurality of movable portions each supported on a fixed substrate elastically displaceably and adapted to be rotationally displaced bidirectionally, each of the movable portions having a modulating function; a plurality of driving portions each adapted to apply a physical acting force to the movable portion on application of a voltage thereto, wherein, by means of the physical acting force from the driving portion, the movable portion is capable of reaching a first stop position where the movable portion is brought into contact with and stops on a side of the fixed substrate after being rotationally displaced in a first direction and of reaching a second stop position where the movable portion is brought into contact with and stops on the side of the fixed substrate after being rotationally displaced in a second direction different from the first direction, wherein if a voltage capable of holding a state of the movable portion at each of the first and second stop positions as it is is set as a hold voltage, and a voltage capable of pulling in the movable portion in a state of being not located at each of the first and second stop positions to each of the first and second stop positions over a transition time is set as a dynamic pull-in voltage, the dynamic pull-in voltage is set to be lower than the hold voltage, and the driving portion drives the movable portion by the drive voltage greater than or equal to the hold voltage, and wherein the drive voltage is less than or equal to 10 V.

The “dynamic pull-in voltage,” i.e., a voltage necessary for pulling the movable portion in to a normal stop position over a transition time (i.e., a voltage concerning the dynamic behavior of the movable portion) is defined. The structure of the movable portion (each of the moment of inertia due to the size of the movable portion, the elastic force of the supporting potion for supporting the movable portion, and a drive voltage value) is designed such that this dynamic pull-in voltage becomes less than or equal to the “hold voltage (a voltage at which the state of the movable portion in the normal stop position can be held as it is, and in a case where there is a margin in that voltage, a minimum voltage within that margin is preferably set as the hold voltage; however, the hold voltage is not limited to the same).” According to this micro-electromechanical modulating element, the movable portion can be appropriately displaced by a low-voltage drive of 10 V or less, and appropriate on/off modulation, for instance, can be implemented.
(2) The micro-electromechanical modulating element according to (1), wherein the movable portion is supported on the fixed substrate by means of an elastically supporting portion, and if a relationship of an elastic force of the elastically supporting portion with respect to a size of the movable portion is plotted into a graph, by using as boundaries a line A indicating a limit of the elastic force of the elastically supporting portion with respect to such a size of the movable portion as to allow the movable portion to be held at each of the first and second stop positions upon application of a predetermined drive voltage to the movable portion, and a line B indicating a limit of the elastic force of the elastically supporting portion with respect to such a size of the movable portion as to allow the movable portion to be pulled in to each of the first and second stop positions over the transition time when the movable portion is driven at the predetermined drive voltage, the elastic force of the elastically supporting portion with respect to the size of the movable portion is defined so as to be included in a region on a side of the line A where the elastic force of the elastically supporting portion becomes low and in a region on a side of the line B where the size of the movable portion becomes small.

According to this micro-electromechanical modulating element, it is possible to optimize the relationship between the size of the movable portion (parameters concerning the moment of inertia and viscosity) and the elastic force of the elastically supporting portion (a parameter due to the response speed based on a force of restitution) so that the element can be driven at a desired low voltage. Namely, the desired drive voltage (this drive voltage is assumed to be equal to the hold voltage) is set to, for example, 3 V, and while changing the respective parameters by small degrees on a plane indicating the relationship between the size of the movable portion and the elastic force of the elastically supporting portion, limiting points are searched at which the movable portion can be held at the normal stop position at the voltage of 3 V or less. Then, a line A (a characteristic line indicating a limit seen from the viewpoint of the hold voltage) is obtained by connecting the respective limiting points. In addition, in a region located in a direction in which the elastic force becomes low relative to that line A, limiting points are searched at which the movable portion finally reaches the stop position (is dynamically pulled in) when the movable portion not located at the stop position is driven at 3 V and under the condition that the involvement of the transition time is allowed. Then, a line B (a characteristic line indicating a limit seen from the viewpoint of the dynamic pull-in voltage) is obtained by connecting the respective limiting points. Then, the elastic force of the elastically supporting portion with respect to the size of the movable portion is defined so as to be included in a region on the side of the line A where the elastic force of the elastically supporting portion becomes low and in a region on the side of the line B where the size of the movable portion becomes small. According to this micro-electromechanical modulating element, the dynamic pull-in voltage can be set to less than or equal to the hold voltage. Therefore, if the drive voltage is greater than or equal to the hold voltage, the movable portion can be displaced and held at the predetermined stop position, thereby making it possible to realize a drive based on a low voltage.
(3) The micro-electromechanical modulating element according to (1) or (2), wherein the predetermined drive voltage is a voltage of 5 V.

According to this micro-electromechanical modulating element, the movable portion can be appropriately displaced by a low-voltage drive of 5 V or less, and appropriate on/off modulation, for instance, can be implemented.
(4) The micro-electromechanical modulating element according to (2) or (3), wherein in a case where an ambient pressure of the movable portion is an atmospheric pressure, if it is assumed that the size of the movable portion is L, and that the supporting portion's elastic force is F, the line A is a line which passes through following points Pᵢ (L, F) (i is an index of a positive integer), and the line B is a line which passes through following points Qᵢ (L, F) (i is an index of a positive integer):
   P₁=(6.00 μm, 3.22×10⁻¹² Nm)
   P₂=(8.00 μm, 4.30×10⁻¹² Nm)
   P₃=(10.0 μm, 5.35×10⁻¹² Nm)
   P₄=(11.5 μm, 6.16×10⁻¹² Nm)
   P₅=(11.6 μm, 6.22×10⁻¹² Nm)
   P₆=(12.0 μm, 6.47×10⁻¹² Nm)
   Q₁=(11.5 μm, 6.22×10⁻¹² Nm)
   Q₂=(11.5 μm, 6.16×10⁻¹² Nm)
   Q₃=(11.6 μm, 5.35×10⁻¹² Nm)
   Q₄=(11.7 μm, 4.30×10⁻¹² Nm)
   Q₅=(11.8 μm, 3.22×10⁻¹² Nm)
   Q₆=(12.0 μm, 2.17×10⁻¹² Nm)
   Q₇=(12.6 μm, 1.12×10⁻¹² Nm)

According to this micro-electromechanical modulating element, since the line A and the line B in the case of the above-described drive at 1 atmospheric pressure and 5 V are accurately defined, the ranges of the size of the movable portion and the elastic force of the elastically supporting portion are clarified.
(5) The micro-electromechanical modulating element according to (2) or (3), wherein in a case where an ambient pressure of the movable portion is approximately 0.5 atmospheric pressure, if it is assumed that the size of the movable portion is L, and that the supporting portion's elastic force is F, the line A is a line which passes through following points Pᵢ (L, F) (i is an index of a positive integer):
   P₁=(6.00 μm, 3.22×10⁻¹² Nm)
   P₂=(8.00 μm, 4.30×10⁻¹² Nm)
   P₃=(10.0 μm, 5.35×10⁻¹² Nm)
   P₄=(12.0 μm, 6.47×10⁻¹² Nm)

According to this micro-electromechanical modulating element, since the line A and the line B in the case of the above-described drive at approximately 0.5 atmospheric pressure and 5 V are accurately defined, the ranges of the size of the movable portion and the elastic force of the elastically supporting portion are clarified.
(6) The micro-electromechanical modulating element according to (1) or (2), wherein the predetermined drive voltage is a voltage of 3 V.

According to this micro-electromechanical modulating element, the movable portion can be appropriately displaced by a low-voltage drive of 3 V or less, and appropriate on/off modulation, for instance, can be implemented.
(7) The micro-electromechanical modulating element according to (6), wherein in a case where an ambient pressure of the movable portion is an atmospheric pressure, if it is assumed that the size of the movable portion is L, and that the supporting portion's elastic force is F, the line A is a line which passes through following points Pᵢ (L, F) (i is an index of a positive integer), and the line B is a line which passes through following points Qᵢ (L, F) (i is an index of a positive integer):
   P₁=(6.00 μm, 1.16×10⁻¹² Nm)
   P₂=(8.00 μm, 1.55×10⁻¹² Nm)
   P₃=(8.20 μm, 1.59×10⁻¹² Nm)
   P₄=(8.30 μm, 1.61×10⁻¹² Nm)
   P₅=(10.0 μm, 1.94×10⁻¹² Nm)
   P₆=(12.0 μm, 2.33×10⁻¹² Nm)
   Q₁=(8.20 μm, 1.59×10⁻¹² Nm)
   Q₂=(8.20 μm, 1.55×10⁻¹² Nm)
   Q₃=(8.30 μm, 1.16×10⁻¹² Nm)
   Q₄=(8.40 μm, 7.75×10⁻¹³ Nm)
   Q₅=(8.70 μm, 3.88×10⁻¹³ Nm)
   Q₆=(9.40 μm, 1.94×10⁻¹³ Nm)

According to this micro-electromechanical modulating element, since the line A and the line B in the case of the above-described drive at 1 atmospheric pressure and 3 V are accurately defined, the ranges of the size of the movable portion and the elastic force of the elastically supporting portion are clarified.
(8) The micro-electromechanical modulating element according to (2) or (3), wherein in a case where an ambient pressure of the movable portion is approximately 0.5 atmospheric pressure, if it is assumed that the size of the movable portion is L, and that the supporting portion's elastic force is F, the line A is a line which passes through following points Pᵢ (L, F) (i is an index of a positive integer), and the line B is a line which passes through following points Qᵢ (L, F) (i is an index of a positive integer):
   P₁=( 6.00 μm, 1.16×10⁻¹² Nm)
   P₂=(8.00 μm, 1.5 5×10⁻¹² Nm)
   P₃=(9.80 μm, 1.90×10⁻¹² Nm)
   P₄=(9.90 μm, 1.92×10⁻¹² Nm)
   P₅=(10.0 μm, 1.94×10⁻¹² Nm)
   P₆=(12.0 μm, 2.33×10⁻¹² Nm)
   Q₁=(9.70 μm, 1. 92×10⁻¹² Nm)
   Q₂=(9.80 μm, 1.90×10⁻¹² Nm)
   Q₃=(9.8 0 μm, 1.5 5×10⁻¹² Nm)
   Q₄=(9.90 μm, 1.16×10⁻¹² Nm)
   Q5=(10.1 μm, 7.75×10⁻¹³ Nm)
   Q₆=(10.5 μm, 3.88×10⁻¹³ Nm)
   Q₇=(11.6 μm, 1.94×10⁻¹³ Nm)

According to this micro-electromechanical modulating element, since the line A and the line B in the case of the above-described drive at approximately 0.5 atmospheric pressure and 3 V are accurately defined, the ranges of the size of the movable portion and the elastic force of the elastically supporting portion are clarified.
(9) The micro-electromechanical modulating element according to (2) or (3), wherein in a case where an ambient pressure of the movable portion is approximately 0.1 atmospheric pressure, and the size of the movable portion is 4 μm to 11.5 μm, if it is assumed that the size of the movable portion is L, and that the supporting portion's elastic force is F, the line A is a line which passes through following points Pᵢ (L, F) (i is an index of a positive integer):
   P₁=(6.00 μm, 1.16×10⁻¹² Nm)
   P₂=(8.00 μm, 1.55×10⁻¹² Nm)
   P₃=(10.0 μm, 1.94×10⁻¹² Nm)
   P₄=(12.0 μm, 2.33×10⁻¹² Nm)

According to this micro-electromechanical modulating element, since the line A and the line B in the case of the above-described drive at approximately 0.1 atmospheric pressure and 3 V are accurately defined, the ranges of the size of the movable portion and the elastic force of the elastically supporting portion are clarified.
(10) The micro-electromechanical modulating element according to (1) or (2), wherein the behavior of the movable portion on application of the drive voltage thereto is one in which a viscous damping ratio ζ of the movable portion satisfies a following formula:
   ζ=(4.83×10⁵±3.88×10⁴)/2ω

(ω: vibrational angular frequency)
(11) The micro-electromechanical modulating element according to (1) or (2), wherein the behavior of the movable portion on application of the drive voltage thereto is one in which a viscous damping ratio ζ of the movable portion satisfies a following formula:
   ζ=(3.79×10⁵±2.86×10⁴) /2ω

(ω: vibrational angular frequency)
(12) The micro-electromechanical modulating element according to (1) or (2), wherein the behavior of the movable portion on application of the drive voltage thereto is one in which a viscous damping ratio ζ of the movable portion satisfies a following formula:
   ζ=(1.34×10⁵±1.30×10⁴)/2ω

(ω: vibrational angular frequency)

By virtue of these configurations (10) to (12), it becomes possible to analyze the relationship between the size of the movable portion of the micro-electromechanical modulating element of a rotating system and the elastic force of the elastically supporting portion, including the effect of viscosity due to the ambient air, and clarify the dynamic behavior of the movable portion. On the basis of its knowledge, it becomes possible to realize a structure whereby the movable portion can be appropriately displaced and held at the final displacement position at a low voltage (e.g. 10 V or less).
(13) The micro-electromechanical modulating element according to any one of (1) to (12), wherein the movable portion is brought into contact with a stopper member disposed at a respective final displacement position and stops thereat.

According to this micro-electromechanical modulating element, when the movable portion has reached the final displacement position, the movable portion is brought into contact with a stopper member and stops the displacing operation, with the result that it is possible to suppress the movable portion from being displaced beyond the final displacement position and from generating large vibrations.
(14) The micro-electromechanical modulating element according to any one of (1) to (13), wherein the physical acting force is applied to a plurality of points of application of the movable portion.

According to this micro-electromechanical modulating element, since the physical acting force is applied to a plurality of points of application of the movable portion, the movable portion can be driven bidirectionally.
(15) The micro-electromechanical modulating element according to any one of (1) to (14), wherein the physical acting force for displacing the movable portion in the first direction and the second direction by the driving portion is an electrostatic force.

According to this micro-electromechanical modulating element, since the physical acting force is an electrostatic force, high-speed displacement of the movable portion becomes possible.
(16) The micro-electromechanical modulating element according to any one of (1) to (15), wherein a planar shape of the movable portion is quadrangular.

According to this micro-electromechanical modulating element, since the movable portion is quadrangular in shape, in a case where a plurality of movable portions are arrayed one-dimensionally or two-dimensionally, the gap between adjacent ones of the movable portions becomes small, so that the installation efficiency can be enhanced.
(17) The micro-electromechanical modulating element according to any one of (1) to (16), wherein a waveform of the physical acting force for rotationally displacing the movable portion includes any one of a rectangular wave, a sine wave, a cosine wave, a sawtooth wave, and a triangular wave.

According to this micro-electromechanical modulating element, the movable portion is rotationally displaced by a waveform including any one of a rectangular wave, a sine wave, a cosine wave, a sawtooth wave, and a triangular wave.
(18) The micro-electromechanical modulating element according to any one of claims (1) to (17), wherein the elastically supporting portion for supporting the movable portion elastically displaceably is formed of a polymeric material.

According to this micro-electromechanical modulating element, by using a polymeric material having a low modulus of elasticity, it is possible to suppress to a low level the elastic force generated in the case where the polymeric material is used as a material of the supporting member. Hence, it is unnecessary to make the size of the supporting member excessively small to generate a small elastic force.
(19) The micro-electromechanical modulating element according to any one of claims 1 to 17, wherein the elastically supporting portion for supporting the movable portion elastically displaceably is formed of any one of a metal material, a resin material, and a hybrid material thereof.

According to this micro-electromechanical modulating element, by using a metal material, the supporting member can be made into a small piece, thereby improving the degree of freedom in designing the shape of the element and attaining a compact size of the element itself. In addition, by using a resin material, it is unnecessary to make the size of the supporting member excessively small. Further, by using a hybrid material combining these materials, it is easily possible to set a desired elastic force.
(20) The micro-electromechanical modulating element according to any one of (1) to (19), further comprising a control portion for controlling the modulating operation by driving the movable portion.

According to this micro-electromechanical modulating element, as the control portion drives the movable portion, the modulating operation can be controlled arbitrarily.
(21) A micro-electromechanical modulating element array comprising the micro-electromechanical modulating elements according to any one of (1) to (20) arrayed one-dimensionally or two-dimensionally.

According to this micro-electromechanical modulating element array, as the micro-electromechanical modulating elements are arrayed one-dimensionally or two-dimensionally, modulation by a plurality of elements becomes simultaneously possible, and in a case where an image signal is modulated, high-speed processing becomes possible.
(22) The micro-electromechanical modulating element array according to (21), wherein each of the micro-electromechanical modulating elements has a drive circuit including a memory circuit, and one of electrodes which are provided on the movable portion and on at least two or more fixed portions opposing the movable portion is a signal electrode to which an element displacement signal from the drive circuit is inputted, while another one thereof is a common electrode.

According to this micro-electromechanical modulating element array, one of an electrode of the movable portion and electrodes provided on at least two or more fixed portions opposing the movable portion is a signal electrode to which an element displacement signal from the drive circuit including a memory circuit is inputted, while another one thereof is a common electrode. Therefore, it is possible to simplify the wiring in the case where an array form is adopted.
(23) An image forming apparatus comprising: a light source; the micro-electromechanical modulating element array according to claim 21 or 22; an illuminating optical system for radiating light from the light source onto the micro-electromechanical modulating element array; and a projecting optical system for projecting the light emergent from the micro-electromechanical modulating element array onto an image forming plane.

According to this image forming apparatus, it is possible to perform image formation at high speed by making use of the low-voltage driven micro-electromechanical modulating element array.
(24) A method of designing a micro-electromechanical modulating element which has a structure with a movable portion supported by an elastically supporting portion, and which is driveable at a low voltage, comprising: a first step of obtaining a characteristic line A by plotting, on a plane indicating a relationship of an elastic force of the elastically supporting portion with respect to a size of the movable portion, a limiting point at which the movable portion can be held at a final displacement position by a desired voltage; a second step of obtaining a characteristic line B by plotting on the plane a limiting point at which the movable portion can be pulled in to the final displacement position over a transition time in a case where the movable portion is driven at the desired voltage; and a third step of determining the elastic force of the elastically supporting portion with respect to the size of the movable portion so as to be included in a region on a side where the elastic force of the elastically supporting portion becomes low by using the line A as a boundary and in a region on a side where the size of the movable portion becomes small by using the line B as a boundary.

By using this technique, it is possible to analyze the mutual relationship among the size of the movable portion (the moment of inertia of the movable portion) viscosity, and the elastic force of the supporting potion, and on the basis of the result of analysis it is possible to realize a structure in which the movable portion is displaced at a low voltage, and the movable portion is held in place.
(25) The method of designing a micro-electromechanical modulating element according to (24), wherein at the time of analyzing the behavior of the movable portion through application of the drive voltage thereto, a viscous damping ratio ζ of the movable portion is determined by a following formula by regarding the damping as mass proportional damping in which the viscous damping ratio is proportional to mass:
   ζ∝α/2ω

(where, α is a viscous damping constant, and ω is a vibrational angular frequency)

Accordingly, it becomes possible to analyze the relationship between the size of the movable portion of the micro-electromechanical modulating element of a rotating system and the elastic force of the elastically supporting portion, including the effect of viscosity due to the ambient air, and clarify the dynamic behavior of the movable portion.

According to the invention, it becomes possible to analyze the relationship between the size of the movable portion of the micro-electromechanical modulating element of a rotating system and the elastic force of the elastically supporting portion, including the effect of viscosity due to the ambient air, and clarify the dynamic behavior of the movable portion. On the basis of its knowledge, it becomes possible to reliably and easily realize a structure whereby the movable portion can be appropriately displaced and held at the final displacement position at a low voltage (e.g. 10 V or less).

### BRIEF DESCRIPTION OF THE DRAWINGS

FIGS. 1A and 1B are conceptual diagrams of a micro-electromechanical modulating element in accordance with the invention, in which FIG. 1A is a perspective view of the micro-electromechanical modulating element, and FIG. 1B is a vertical cross-sectional view thereof;

FIGS. 2A to 2C are conceptual diagrams respectively illustrating the steps of operation of the micro-electromechanical modulating element;

FIG. 3 is a diagram illustrating a static relationship between an applied voltage and a displacement angle of the micro-electromechanical modulating element shown in FIGS. 1A and 1B;

FIG. 4 is a diagram illustrating examples of the behavior of a movable portion with the lapse of time when the hold voltage (Va) was applied to the respective micro-electromechanical modulating elements with structures A and B having the static characteristics shown in FIG. 3;

FIG. 5 is a diagram illustrating examples of the behavior of the movable portion with the lapse of time when the hold voltage (Va) was applied to the respective micro-electromechanical modulating elements with the structures A and B having the static characteristics shown in FIG. 3 under ambient pressures of 1 atm and 0.1 atm;

FIG. 6 is a diagram illustrating the manner of change of the rotation angle with respect to the elapsed time in a case where the movable portion is driven at a low voltage;

FIG. 7 is an explanatory diagram of the dynamic balance of the external force loaded to the movable portion;

FIG. 8 is a characteristic diagram for explaining an appropriate relationship between the size of the movable portion and the elastic force of a supporting portion (hinge) under the conditions of 3 V drive and 1 atmospheric pressure;

FIG. 9 is a characteristic diagram for explaining an appropriate relationship between the size of the movable portion and the elastic force of the supporting portion (hinge) under the conditions of 3 V drive and 0.5 atmospheric pressure;

FIG. 10 is a characteristic diagram for explaining an appropriate relationship between the size of the movable portion and the elastic force of the supporting portion (hinge) under the conditions of 3 V drive and 0.1 atmospheric pressure;

FIGS. 11A, 11B, and 11C are diagrams for explaining bases for determining characteristic lines X1, X2, and X3 shown in FIGS. 8, 9, and 10, respectively;

FIGS. 12A and 12B are diagrams illustrating bases for determining characteristic lines Y1 and Y2 shown in FIGS. 8 and 9, respectively;

FIG. 13 is a characteristic diagram for explaining an appropriate relationship between the size of the movable portion and the elastic force of the supporting portion (hinge) under the conditions of 5 V drive and 1 atmospheric pressure;

FIG. 14 is a characteristic diagram for explaining an appropriate relationship between the size of the movable portion and the elastic force of the supporting portion (hinge) under the conditions of 5 V drive and 0.5 atmospheric pressure and 0.1 atmospheric pressure;

FIGS. 15A, 15B, and 15C are diagrams for explaining bases for determining characteristic lines X4 and X5 shown in FIGS. 13 and 14, respectively;

FIG. 16 is a diagram illustrating a basis for determining a characteristic line Y4 shown in FIG. 13;

FIG. 17 is a diagram illustrating detailed examples of the structure of the micro-electromechanical modulating element in accordance with an embodiment;

FIG. 18 is a diagram for explaining specific examples of the design of the structure in which, in a case where the micro-electromechanical modulating elements having structures shown in FIGS. 23A and 23B and detailed structures shown in FIG. 17 are driven under 1 atmospheric pressure and at 3 V, the movable portion is brought into contact with a stop position and is held thereat;

FIG. 19 is a diagram for explaining specific examples of the design of the structure in which, in a case where the micro-electromechanical modulating elements having structures shown in FIGS. 23A and 23B and detailed structures shown in FIG. 17 are driven under 1 atmospheric pressure and at 5 V, the movable portion is brought into contact with the stop position and is held thereat;

FIG. 20 is a diagram illustrating the configuration of an apparatus for determining a viscous damping coefficient;

FIG. 21 is a diagram illustrating a relationship between the vibrational angular frequency and the damping ratio;

FIGS. 23A and 23B are diagrams illustrating the configuration of a model of the micro-electromechanical modulating element in accordance with the invention, in which FIG. 23A is a plan view, and FIG. 23B is a cross-sectional view taken along line P₁-P₁ of FIG. 23A;

FIGS. 24A to 24D are diagrams illustrating the configuration of a conventional model for comparison with the model of the micro-electromechanical modulating element in accordance with the invention, in which FIG. 24A is a plan view, FIG. 24B is a left side elevational view, FIG. 24C is a plan view as taken in a direction of P2-P2 of FIG. 24B, and FIG. 24D is a lower side elevational view;

FIGS. 25A to 25C respectively illustrate other examples of the configuration of the micro-electromechanical modulating element;

FIG. 26 is an explanatory diagram illustrating a configuration in which each of a plurality of micro-electromechanical modulating elements has a drive circuit including a memory circuit;

FIG. 27 is a diagram illustrating a schematic configuration of an exposing apparatus constructed by using the micro-electromechanical modulating element array in accordance with the invention; and

FIG. 28 is a diagram illustrating a schematic configuration of a projecting apparatus constructed by using the micro-electromechanical modulating element array in accordance with the invention.

### DESCRIPTION OF REFERENCE NUMERALS AND SIGNS

11: substrate
13: gap
15: movable portion
15A, 15B, 15C: movable portions
17: hinge
19a, 19b: spacers
21a: first address electrode
21b: second address electrode
23: drive circuit
25: supporting post
37: memory circuit
39: drive voltage controlling circuit
41: illuminating light source
43: illuminating optical system
45: projecting optical system
47: recording medium
49: light absorber
51: projecting optical system
53: screen
θ: angle of inclination
T: transition time
K: supporting portion's elastic force
ω: vibrational angular frequency
100: micro-electromechanical modulating element
200: micro-electromechanical modulating element array
300: exposing apparatus
400: projector

### DETAILED DESCRIPTION OF THE INVENTION

Referring now to the accompanying drawings, a detailed description will be given of the preferred embodiments of a micro-electromechanical modulating element, a micro-electromechanical modulating element array, an image forming apparatus, and a method of designing a micro-electromechanical modulating element in accordance with the invention.

### First Embodiment

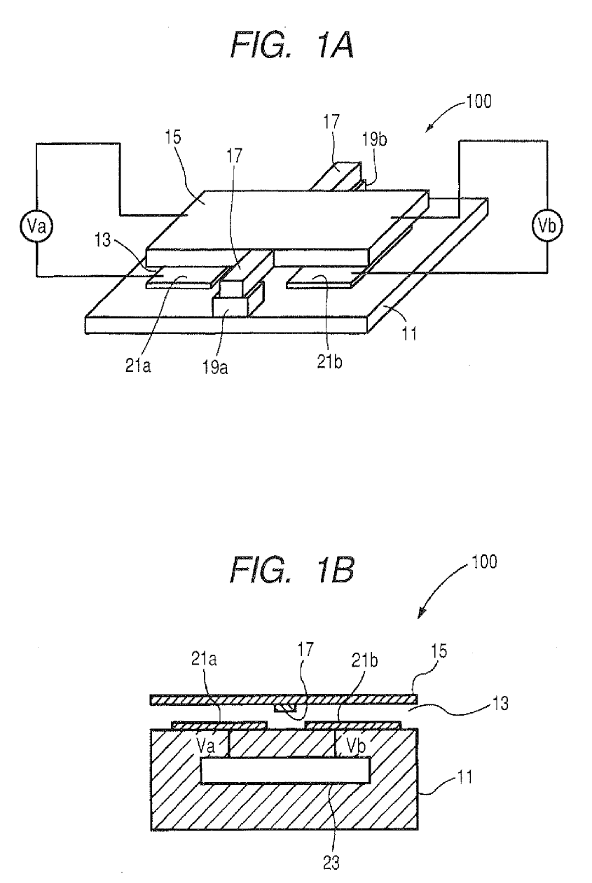

FIGS. 1A and 1B are conceptual diagrams of the micro-electromechanical modulating element in accordance with the invention, in which FIG. 1A is a perspective view of the micro-electromechanical modulating element, and FIG. 1B is a vertical cross-sectional view thereof.

A micro-electromechanical modulating element 100 in accordance with this embodiment has as its basic constituent elements a substrate 11; a movable portion 15 in the form of a small piece disposed over the substrate 11 parallel thereto with a gap provided therebetween; a hinge 17 which is an elastically supporting portion connected to the substrate 11-side surface of the movable portion 15 to support the movable portion 15; a pair of spacers 19a and 19b for supporting the movable portion 15 over the substrate 11 by means of this hinge 17; and a first address electrode 21a and a second address electrode 21b which are drive electrodes (fixed electrodes) disposed on both sides with the hinge 17 as a center. In addition, the movable portion 15 is electrically conductive in itself or has a movable electrode in its part. Further, a drive circuit 23 is provided in the substrate 11. Owing to the above-described configuration, as the hinge 17 is swung, the movable portion 15 can be rotationally displaced and rotationally driven in an arbitrary direction by using the hinge 17 as an axis in correspondence with voltages applied by the drive circuit 23.

It should be noted that the drive circuit 23 applies voltages for producing potential differences between the movable portion 15 (movable electrode) and the first address electrode 21a and between the movable portion 15 (movable electrode) and the second address electrode 21b.

In the micro-electromechanical modulating element 100, the upper surface of the movable portion 15 serves as a light reflecting portion (micro mirror portion) Since the planar shape of the movable portion 15 is quadrangular, in a case where a plurality of movable portions are arrayed one-dimensionally or two-dimensionally, the gap between adjacent ones of the movable portions becomes small, so that the installation efficiency can be enhanced. In addition, as the material of the movable portion 15 is appropriately selected, or a short-circuit contact or the like is additionally provided, the micro-electromechanical modulating element 100 in accordance with the invention can be made to function as a light modulation switch, a light changeover switch, or an electrical switch. Further, the switching of acoustic waves, a fluid, and heat rays, or the switching of an RF signal also becomes possible.

In this embodiment, at the time of reaching a final displacement position in the rotating operation in a specific direction, the movable portion 15 is brought into contact with a stopper member and stops. As a result, it is possible to suppress the movable portion 15 from being displaced beyond the final displacement position and from generating large vibrations. In the illustrated example, the surface of the movable portion 15 is covered with an insulating material, and the first address electrode 21a and the second address electrode 21b function as stopper members. Namely, the micro-electromechanical modulating element 100 in this configuration is of a contact type.

In terms of the basic operation of the micro-electromechanical modulating element 100, the movable portion 15 is swingably displaced by using the hinge 17 as a swinging center as voltages are applied to the first address electrode 21a, the second address electrode 21b, and the movable portion 15, respectively. Namely, since the movable portion 15 is the micro mirror portion, the reflecting direction of the light radiated to the micro mirror portion is switched.

Specifically, if the drive circuit 23 imparts potential differences to the first address electrode 21a and the second address electrode 21b with respect to the movable portion 15, an electrostatic force is generated as a physical acting force between the movable portion 15 and each of the first address electrode 21a and the second address electrode 21b, whereby a rotational torque centered around the hinge 17 acts in the movable portion 15. The relative magnitude of the electrostatic force generated at this time is dependent on the dielectric constant of the ambient atmosphere, the area of the movable portion 15 (electrode area), the applied voltages, and the electrode gap between the movable portion 15 and each of the address electrodes 21a and 21b.

If it is assumed that the potential difference between the movable portion 15 and the first address electrode 21a is Va, and that the potential difference between the movable portion 15 and the second address electrode 21b is Vb, when, for example, Va>Vb, the electrostatic force generated between the first address electrode 21a and the movable portion 15 becomes greater than the electrostatic force generated between the second address electrode 21b and the movable portion 15, so that the movable portion 15 is tilted such that its left side is lowered. Conversely, when Va<Vb, the electrostatic force generated between the second address electrode 21b and the movable portion 15 becomes greater than the electrostatic force generated between the first address electrode 21a and the movable portion 15, so that the movable portion 15 is tilted such that its right side is lowered.

Thus, the movable portion (movable electrode) 15, the first address electrode 21a, the second address electrode 21b, and the drive circuit 23 constitute driving means for rotationally displacing the movable portion 15. Since the physical acting force applied from such driving means to the movable portion 15 is the electrostatic force, high-speed rotational displacement of the movable portion 15 becomes possible.

It should be noted that physical acting force applied to the movable portion 15 may be a physical acting force other than the electrostatic force. As the other physical acting forces, it is possible to adopt arbitrary means including an electromagnetic force based on an electromagnet, electrostriction based on a piezoelectric element, a mechanical means, and the like.

Thus, the micro-electromechanical modulating element 100 has the movable portion 15 which is displaced bidirectionally, and this movable portion 15 has a switching function. The movable portion 15 is rotationally displaced against the gravity and the resiliency of the hinge 17 by the plurality of driving means (the movable electrode of the movable portion 15, the first address electrode 21a, the second address electrode 21b, and the drive circuit 23) for applying a physical acting force.

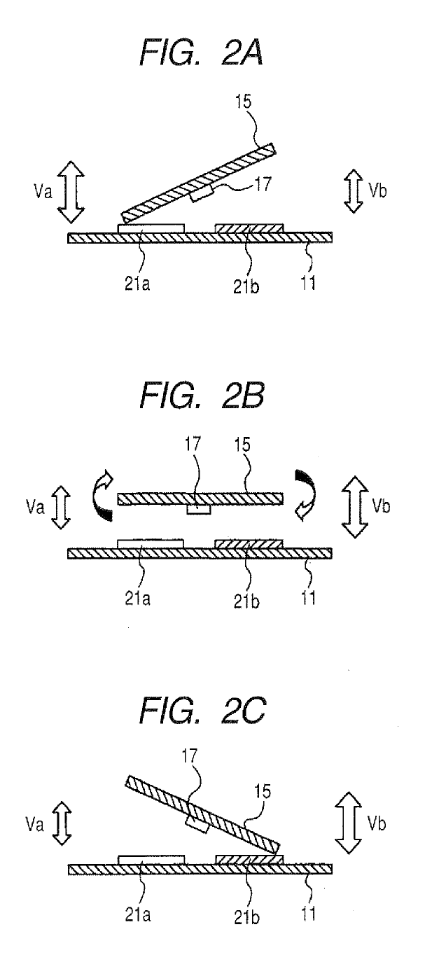

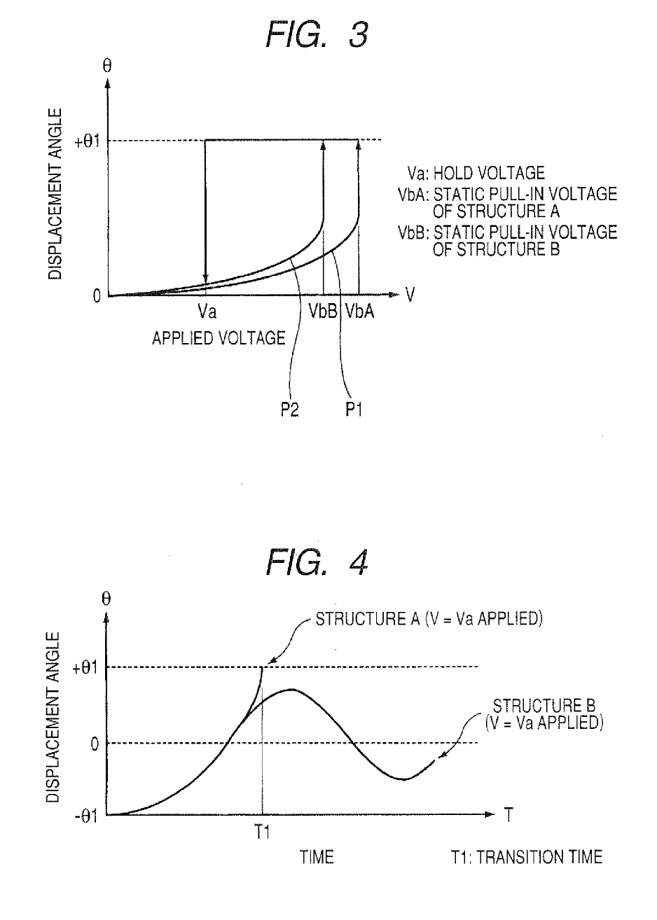

Next, referring to FIGS. 2A to 2C and FIG. 3, a more detailed description will be given of the operation of the micro-electromechanical modulating element 100 in accordance with the invention.

FIGS. 2A to 2C are conceptual diagrams respectively illustrating the steps of operation of the micro-electromechanical modulating element.

In a state in which no voltage is being applied from the drive circuit 23, if the potential difference Va between the first address electrode 21a and the movable portion 15 is made greater than the potential difference Vb between the second address electrode 21b and the movable portion 15, an electrostatic force with which the movable portion 15 is attracted by the first address electrode 21a is applied to the movable portion 15. As shown in FIG. 2A, this electrostatic force twists the hinge 17 counterclockwise against its resiliency and tilts the movable portion 15 counterclockwise. At this time, elastic energy in an amount proportional to the swing angle of the hinge 17 is accumulated in the hinge 17.

As the potential difference Va for generating an electrostatic force greater than the elastic energy accumulated in the hinge 17 is continued to be imparted across the movable portion 15 and the first address electrode 21a, the movable portion 15 is held in a state of being tilted counterclockwise.

Next, as shown in FIG. 2B, if the potential difference between the movable portion 15 and the first address electrode 21a is removed to release the elastic energy accumulated in the hinge 17, and the potential difference Vb for generating the electrostatic force is imparted across the movable portion 15 and the second address electrode 21b, the movable portion 15 starts to rotate clockwise.

Then, as shown in FIG. 2C, after the movable portion 15 is brought into contact with the second address electrode 21b, the movable portion 15 is held again in a state of being tilted clockwise. Subsequently, similar operation is repeatedly performed each time the potential differences Va and Vb are respectively removed and applied.

A pull-in phenomenon thus takes place in which the movable portion 15 is rotationally displaced by the electrostatic force, and a distal end of the movable portion 15 suddenly plunges downward. The movable portion 15 is hence attracted (stuck) onto the substrate 11. Namely, the movable portion 15 is displaced by the electrostatic force which is generated by pull-in voltages which are applied to the movable electrode of the movable portion 15, the first address electrode 21a, and the second address electrode 21b. The movable portion 15 which has been pulled in on the first address electrode 21a side is held in the pulled-in state (the state shown in FIG. 2A) as a pull-out voltage which is lower than the pull-in voltage is applied to the first address electrode 21a.

In the element 100 of the bidirectionally driven rotating system having the movable portion 15 structured as described above, when the movable portion 15 is made to undergo a transition from −θ to +θ in the rotation angle by applying, across the respective electrodes of the second address electrode 21b and the movable portion (movable electrode) 15, such a voltage that the interelectrode potential difference becomes Vb, if the moment of inertia of the element is assumed to be J=J1, a transition time T until the rotation angle of the movable portion 15 reaches the final position of +θ from the initial position of −θ is determined by a supporting portion's elastic force K of the hinge 17, i.e., the elastically supporting portion, or by a vibrational angular frequency ω corresponding to the supporting portion's elastic force K.

The elastically supporting portion can be formed of a metal such as aluminum. Further, by using a polymeric material having a low modulus of elasticity, it is possible to suppress to a low level the elastic force generated in the case where the polymeric material is used as a material of the supporting member. In this case, it is unnecessary to make the size of the supporting member excessively small to generate a small elastic force. In addition, the elastically supporting portion may be formed of a metal material, a resin material, a hybrid material thereof, or a dielectric material. In the case where a metal material is used, the elastically supporting portion can be made into a small piece, thereby improving the degree of freedom in designing the shape of the element and attaining a compact size of the element itself. In addition, in the case where a resin material is used, it is unnecessary to make the size of the elastically supporting portion excessively small. In the case where a hybrid material combining these materials is used, it is easily possible to set a desired elastic force. Furthermore, it is possible to use any material other than these materials insofar as it exhibits the advantages of the invention.

(Analysis of Dynamic Behavior of Micro-Electromechanical Modulating Element for Realizing Low-Voltage Drive)

In order to drive the micro-electromechanical modulating element having the above-described structure at 10 V or less (e.g., 5 V or 3 V), it is insufficient to observe only the static condition of the micro-electromechanical modulating element, and it is necessary to observe in detail the dynamic behavior which takes the viscosity of air into consideration. First, a description will be given of this aspect.

FIG. 3 is a diagram illustrating a static relationship between the applied voltage and the displacement angle of the micro-electromechanical modulating element shown in FIGS. 1A and 1B. The term “static relationship” referred to herein means a relationship when the movable portion of the modulating element shown in FIGS. 1A and 1B is displaced under such an environment that its dynamic behavior during the course of displacement is negligible.

In FIG. 3, P1 indicates a hysteresis characteristic of a structure A, and P2 indicates a hysteresis characteristic of a structure B. As shown in the drawing, the displacement angle gradually becomes large with an increase in the applied voltage from 0 V. The structure B, upon reaching VbB, is instantaneously displaced by +θ1 (final displacement position), and the structure A, upon reaching VbA, is similarly instantaneously displaced by +θ1 (final displacement position). Subsequently, even if the applied voltage is gradually lowered, one end of the movable portion 15 in both the structures A and B remains fixed at the final displacement position for some time. However, when the applied voltage reaches Va, the elastic force of the hinge 17 surpasses the attraction based on the electrostatic force, and it becomes impossible to maintain the state of the movable portion 15, so that the movable portion 15 is greatly displaced in the opposite direction. Here, if a drive voltage necessary for maintaining a state persisting when the movable portion 15 is at the final displacement position +θ1 (stop position) is referred to as a hold voltage, it can be said that “Va” in FIG. 3 is a minimum hold voltage. Hereafter, Va will be referred to as the hold voltage. In addition, each of VbB and VbA is a drive voltage at which an instantaneous pull-in occurs, and this will be referred to as a static pull-in voltage.

What can be understood from the characteristics of FIG. 3 is that although the structures A and B are different in the size of the movable portion, they have the common hold voltage Va, and that the static pull-in voltages (VbA, VbB) of both structures are different. However, concerning the structures A and B, the mere observation of the hysteresis characteristics of FIG. 3 yields no information on what behavior the movable portion 15 exhibits with the lapse of time when the drive voltage is lowered to an extreme level.

FIG. 4 is a diagram illustrating examples of the behavior of the movable portion with the lapse of time when the hold voltage (Va) was applied to the respective micro-electromechanical modulating elements with the structures A and B having the static characteristics shown in FIG. 3.

As described before, both the structures A and B have the same hold voltage Va. However, since the size of the movable portion 15 is different, the static pull-in voltage and the vibrational frequency differ. If a comparison is made of the displacement of the movable portion 15 when the hold voltage Va is applied to the both structures, the structure A reaches the final displacement position after the lapse of a transition time (T1), but the structure B does not reach it and repeats free vibration. In the structure A, at the address electrode V=Va (hold voltage), the distal end of the movable portion 15 is pulled in and brought into contact with the address electrode, and its state is held.

Here, if, as with the structure A, when the drive voltage Va (=hold voltage) is applied, the distal end of the movable can be pulled in to the final displacement position and can be held thereat, the movable portion can be driven appropriately with a minimum voltage. Namely, at the time of designing a rotating system element which is driven at an arbitrary drive voltage Va set in advance, the relationship between the size of the movable portion and the elastic force of the elastically supporting portion (hinge) is optimized such that the movable portion is pulled in and brought into contact with the stop position and is held thereat by means of that drive voltage Va, thereby making it possible to obtain a micro-electromechanical modulating element suitable for low-voltage driving.

In addition, as the drive voltage is lowered, and the size of the movable portion of the micro-electromechanical modulating element is made smaller, a conventionally different effect due to the viscosity of air may conceivably appear. Hence, it becomes essential to perform a detailed computer simulation of the dynamic behavior of the movable portion which also takes the viscosity of air into consideration. Namely, it becomes necessary to analyze the behavior involving the lapse of time, such as whether, after the elapsing of the transition time, the movable portion is subsequently pulled in to the stop position and is held thereat, or vibrates freely without being pulled in, as shown in FIG. 4, or although it is pulled in and reaches the stop position, it cannot maintain its state and moves away from it.

Accordingly, in the invention, by using the below-described analytical approach, a detailed analysis of the dynamic behavior of the low-voltage driven movable portion is made possible in a region which is of a smaller size than before and for which information on the effect of viscosity has been insufficient. Further, on the basis of the data obtained by the analysis, a determination is made of in what relational region the size of the movable portion and the elastic force of the elastically supporting portion (hinge) are, a micro-electromechanical modulating element suitable for the low-voltage drive can be obtained. The structure of the micro-electromechanical modulating element is designed so that the size of the movable portion and the elastic force of the elastically supporting portion fall within the determined region. The determination of such a region in accordance with the invention becomes possible for the first time by the detailed analysis of the dynamic behavior which takes the viscosity into consideration.

Next, a description will be given of the effect of the viscosity.

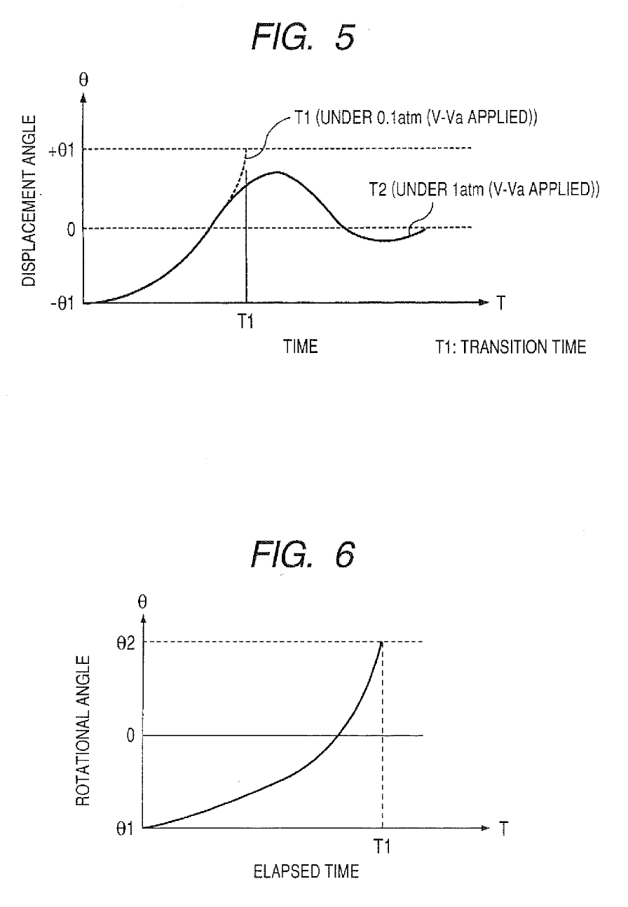

FIG. 5 is a diagram illustrating examples of the behavior of the movable portion with the lapse of time when the hold voltage (Va) was applied to the respective micro-electromechanical modulating elements with the structures A and B having the static characteristics shown in FIG. 3 under ambient pressures of 1 atm and 0.1 atm.

When the movable portion is displaced from θ1 to θ2 under the effect of viscosity, the angular degree through which the movable portion is maximally displaced changes depending on the degree of the effect. The movable portion is or is not brought into contact with the stop position depending on the magnitude of the effect. Namely, in the case where the rotating system element which is driven at the arbitrary voltage Va is designed, the range of the structure which is displaced and held changes due to the effect of viscosity.

In FIG. 5, the behavior of vibration under 1 atmospheric pressure and 0.1 atmospheric pressure is shown with respect to the elements of the same structure. T1 indicated by the dotted line shows the behavior of the movable portion when the voltage Va was applied under 0.1 atmospheric pressure, while T2 indicated by the solid line shows the behavior of the movable portion when the voltage Va was applied under 1 atmospheric pressure.

Under 1 atmospheric pressure at which the viscous effect is large, the amplitude of the movable portion is attenuated, and the movable portion cannot reach the stop position at the applied voltage of Va. On the other hand, under 0.1 atmospheric pressure at which the viscous effect is small, the attenuation of the amplitude is small, and a dynamic pull-in is generated by the applied voltage of Va, so that the movable portion reaches the stop position.

Thus, to analyze the behavior of the movable portion under a low voltage, the effect of viscosity cannot be ignored.

(Method of Analyzing Dynamic Behavior of Micro-Electromechanical Modulating Element)

Next, a description will be given of the method of analyzing the dynamic behavior of the micro-electromechanical modulating element.

The time during which the movable portion undergoes a transition from a specific rotation angle −θ to +θ and reaches the final displacement position was calculated by using an equation of motion shown in Formula (1) below. The interelectrode gap between the movable portion (movable electrode) and the first or second address electrode 21a or 21b changes momentarily in correspondence with the amount of displacement of the movable portion, and the electrostatic force acting between the electrodes also changes over time. For this reason, an operation was repeated in which an external force moment Fₙ and an angle θₙ after the lapse of a certain time t were determined, and an external force moment F_{n|1} and an angle θ_{n|1} after the lapse of an infinitesimal time Δt were further determined by using that external force moment Fₙ. The time-variable relationship of the angle of the movable portion was finally calculated.

Equation of motion:

$$J \frac{{ⅆ}^{2} θ}{ⅆ {t}^{2}} + a \frac{ⅆ θ}{ⅆ t} + K θ = {F}_{1} \qquad ( 1 )$$

Moment of inertia:

$$J = \frac{{ML}_{2}^{2}}{12} = \frac{{L}_{1} {L}_{2}^{3} H ρ}{12} \qquad ( 2 )$$

Viscous damping coefficient: a

Supporting portion's elastic force:

$$K = 2 \frac{kG}{{l}_{1}} = \frac{k E}{{l}_{1} ( l + v )} \qquad ( 3 )$$

Where,

$$k = \frac{{h}^{3} {l}_{2}}{4} [ \frac{16}{3} - 3.36 \frac{h}{{l}_{2}} ( 1 - \frac{{h}_{4}}{12 {l}_{2}^{4}} ) ] \qquad ( 4 )$$

External force moment:

$${F}_{1} = \frac{{ɛ}_{0} {SV}^{2}}{2 {ⅆ}^{2}} \times \frac{{L}^{2}}{4} = \frac{{ɛ}_{0} {L}_{1} {L}_{2}^{2} {V}^{2}}{16 {ⅆ}^{2}} \qquad ( 5 )$$

Vibrational angular frequency:

$$ω = \sqrt{\frac{k}{J} - \frac{{a}^{2}}{4 {J}^{2}}} \qquad ( 6 )$$

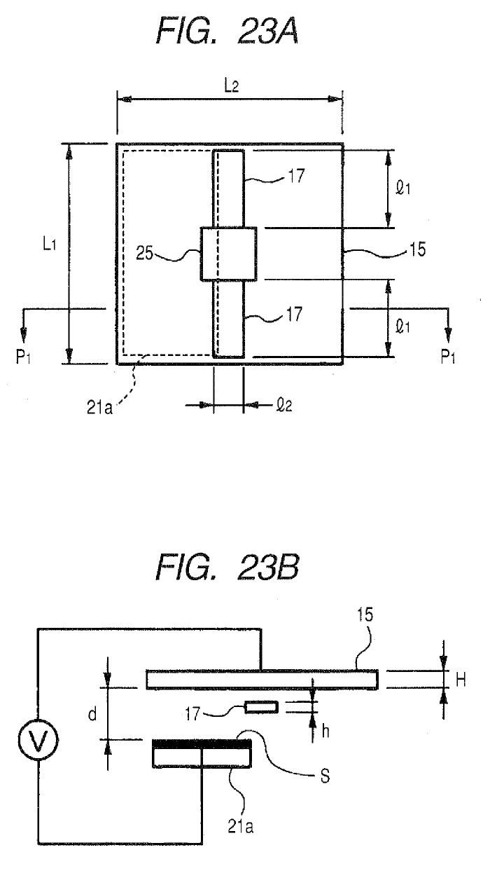

The respective symbols which are not explained in the formulae above are as shown in FIGS. 23A and 23B which will be referred to later.

Here, if it is assumed that the initial rotation angle of the movable portion is θ₁, ω_{C}²=K/J, and 2μ=a/J, and if the equation of motion in Formula (1) is solved, Formula (7) is derived.

$$θ = \{ \frac{{F}_{1}}{K} - {θ}_{1} \} \cdot \{ - exp ( - μ t ) \cdot cos ( \sqrt{{ω}_{0}^{2} - {μ}^{2} t} ) + \frac{{F}_{1}}{{F}_{1} - K {θ}_{1}} \} \qquad ( 7 )$$

If it is assumed that, at the time of performing coupled analysis of the rotation angle θ and the external force moment F, a rotation angle at a certain time t is θₙ, that an external force moment is F₁n, and that a rotation angle after the lapse of an infinitesimal time is θₙ₊₁, θₙ₊₁ can be determined by Formula (8):

$${θ}_{n + 1} = \{ \frac{{F}_{1} n}{K} - {θ}_{1} \} \cdot \{ - exp ( - μ t ) \cdot cos ( \sqrt{{ω}_{0}^{2} - {μ}^{2} t} ) + \frac{{F}_{1} n}{{F}_{1} n - K {θ}_{1}} \} \qquad ( 8 )$$

FIG. 6 shows the manner of change of the rotation angle with respect to the elapsed time. The rotation angle of the movable portion is θ₁ at its initial position and reaches θ₂ after the lapse of a time T1 (when θₙ₊₁=θ₂, the movable portion touches the lower part). If it is assumed that the time when the movable portion reaches θ₂ after being rotationally displaced is T1, this T1 constitutes the transition time. The foregoing analysis was conducted by variously changing the size of the movable portion, the supporting portion's elastic force, the applied voltage, and the like. The coupled analysis in which the rotation angle θₙ and the external force moment F are alternately determined is made possible, as shown in Formulae (7) and (8) above, and vibrational analysis for each time step can be conducted.

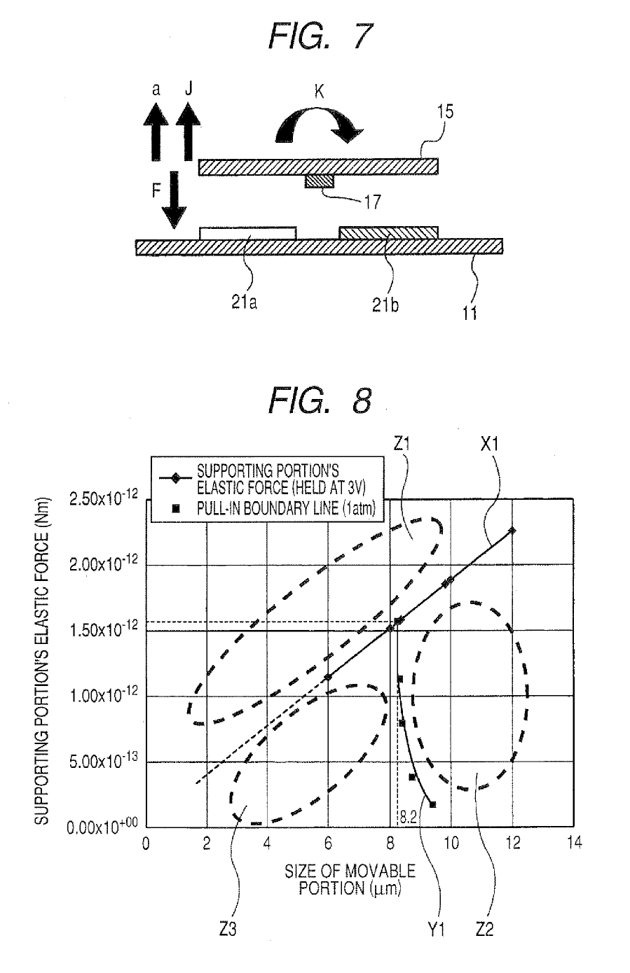

FIG. 7 is an explanatory diagram of the dynamic balance of the external force loaded to the movable portion.

As shown in the drawing, as a predetermined potential difference is provided between the movable portion 15 and the first address electrode 21a, the external force moment F acts in the movable portion 15 in a direction in which the movable portion 15 is attracted toward the first address electrode 21a side. At this time, the moment of inertia J corresponding to the mass M of the movable portion and a drag force based on the viscous damping coefficient a of the ambient atmosphere are simultaneously generated in an opposite direction to that of the external force moment F. In addition, the supporting portion's elastic force K with which the hinge 17, i.e., the elastically supporting portion, tends to return from a twisted state is also generated in the opposite direction.

The viscous damping coefficient a is a coefficient which is proportional to the velocity, and the damping force is generally produced in proportion to the velocity. Concerning the viscosity, a specific description will be given in a second embodiment.

(Design Standard of Low-Voltage Drivable Structure)

As described earlier, in order to appropriately drive the movable portion by the low-voltage drive, it is minimally necessary to satisfy the following two conditions: the structure is such that when the drive voltage Va is applied, the movable portion at the stop position can be held as it is in that state (holding condition); and the structure is such that when the movable portion is not at the stop position, the movable portion is pulled in and is displaced with the lapse of time, and in due course reaches the final displacement position (dynamic pull-in condition).

To satisfy these conditions, it is necessary that the structure satisfies the relationship (necessary condition) of “hold voltage≧dynamic pull-in voltage” (and that a voltage greater than or equal to the hold voltage is applied at the time of the actual driving) To clarify the range of such a structure as to satisfy the above-described necessary condition, analysis based on simulation was carried out by using the above-described analytical approach.

(Results of Analysis Based on Simulation)

(1) Drive Voltage of 3 V (FIGS. 8 to 12)

The MEMS element chip in accordance with this embodiment is driven at a drive voltage of 3 V or 5 V. Here, analysis was performed by setting such a supporting portion's elastic force that 3 V became the hold voltage depending on the size of each movable portion.

FIG. 8 is a characteristic diagram for explaining an appropriate relationship between the size of the movable portion and the elastic force of the supporting portion (hinge) under the conditions of 3 V drive and 1 atmospheric pressure.

First, limiting points at which the movable portion could be held at the stop position by 3 V was examined. In FIG. 8, the characteristic line X1 shows a limit (boundary) at which the movable portion can be held at the stop position by 3 V. Namely, since a hold voltage higher than 3 V is required in a region Z1 above the characteristic line X1, the region Z1 above the characteristic line X1 falls outside the scope of design. In other words, a region below the characteristic line X1 (Z2+Z3) is the region where the movable portion can be held at the stop position, and it can be said that the scope of design is located in this region.

Further, in FIG. 8, the characteristic line Y1 shows a limit at which the dynamic pull-in is possible by the 3 V drive, and in the region Z2 on the right side of the characteristic line Y1 the movable portion does not undergo a dynamic pull-in, and the movable portion does not reach the stop position even after the lapse of the transition time. The region Z3 on the left side of the characteristic line Y1 is the region where the dynamic pull-in occurs at 3 V, and this region Z3 indicates an appropriate scope of structural design. As is apparent from FIG. 8, 8.2 μm is a boundary point of the size of the movable portion at 1 atmospheric pressure. Accordingly, in a case where the size of the movable portion is not less than 4 μm and less than 8.2 μm, the region where the dynamic pull-in occurs is limited by the characteristic line X1, and in a case where the size of the movable portion is not less than 8.2 μm and less than 9.0 μm, the region is limited by the characteristic line Y1.

Namely, the region Z3 on the lower side of the characteristic line X1 and on the left side of the characteristic line Y2 is the region of the structure in which the movable portion reaches the stop position and is held thereat at 3 V. It therefore suffices if the structure of the micro-electromechanical modulating element is designed so as to be accommodated in this range.

Here, the characteristic line X1 can be defined as follows.

In the case where the ambient pressure of the movable portion is the atmospheric pressure, if it is assumed that the size of the movable portion is L, and that the supporting portion's elastic force is F, the characteristic line X1 (line A) is a line which passes through the following points Pᵢ (L, F) (i is an index of a positive integer):
P₁=(6.00 μm, 1.16×10⁻¹² Nm)
P₂=(8.00 μm, 1.55×10⁻¹² Nm)
P₃=(8.20 μm, 1.59×10⁻¹² Nm)
P₄=(8.30 μm, 1.61×10⁻¹² Nm)
P₅=(10.0 μm, 1.94×10⁻¹² Nm)
P₆=(12.0 μm, 2.33×10⁻¹² Nm)

In addition, as for the aforementioned characteristic line X1, the supporting portion's elastic force F and the size L of the movable portion can be expressed by the following relational expression by linear approximation:
F=1.95×10⁻⁷L−1.0×10⁻¹⁴

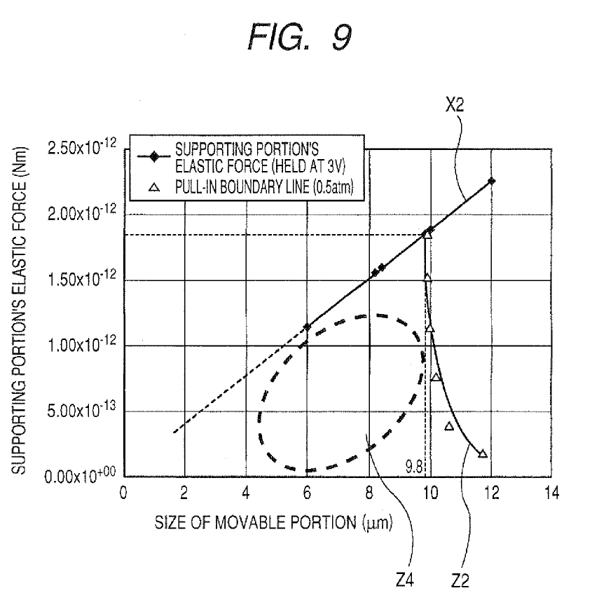

FIG. 9 is a characteristic diagram for explaining an appropriate relationship between the size of the movable portion and the elastic force of the supporting portion (hinge) under the conditions of 3 V drive and 0.5 atmospheric pressure. An approach to viewing FIG. 9 is similar to that of FIG. 8, and the region Z4 on the lower side of the characteristic line X2 and on the left side of the characteristic line Y2 is an appropriate range of the structure. As is apparent from FIG. 9, 9.8 μm is a boundary point of the size of the movable portion of 0.5 atmospheric pressure.

The characteristic line X2 in this case can be defined as follows.

The characteristic line X2 (line A) is a line which passed through the following points Pᵢ (L, F) (i is an index of a positive integer):
P₁=(6.00 μm, 1.16×10⁻¹² Nm)
P₂=(8.00 μm, 1.55×10⁻¹² Nm)
P₃=(9.80 μm, 1.90×10⁻¹² Nm)
P₄=(9.90 μm, 1.92×10⁻¹² Nm)
P₅=(10.0 μm, 1.94×10⁻¹² Nm)
P₅=(12.0 μm, 2.33×10⁻¹² Nm)

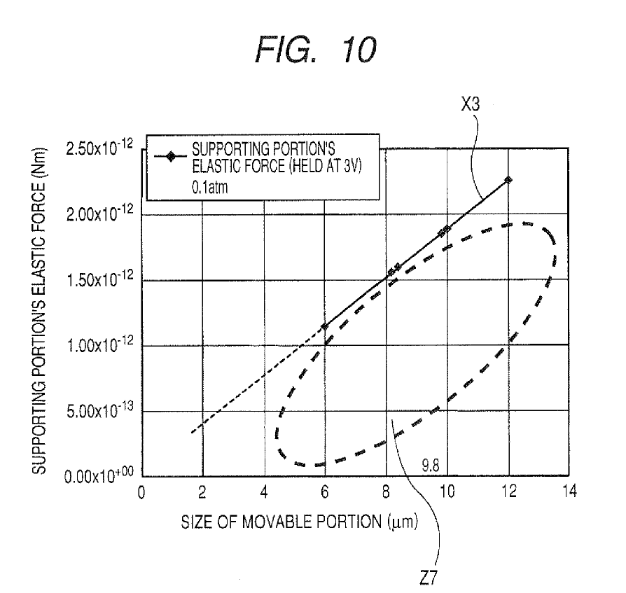

FIG. 10 is a characteristic diagram for explaining an appropriate relationship between the size of the movable portion and the elastic force of the supporting portion (hinge) under the conditions of 3 V drive and 0.1 atmospheric pressure. An approach to viewing FIG. 9 is similar to those of FIGS. 8 and 9. However, if the atmospheric pressure drops, the viscosity declines, and the movable portion becomes easily rotatable. Therefore, if the range is such that the movable portion can be held at the stop position at 3 V (region Z in FIG. 10), the dynamic pull-in is also possible, so that the boundary point of the movable size does not exist in FIG. 10.

The characteristic line X3 in this case can be defined as follows.

The characteristic line X3 (line A) is a line which passes through the following points Pᵢ (L, F) (i is an index of a positive integer):
P₁=(6.00 μm, 1.16×10⁻¹² Nm)
P₂=(8.00 μm, 1.55×10⁻¹² Nm)
P₃=(10.0 μm, 1.94×10⁻¹² Nm)
P₄=(12.0 μm, 2.33×10⁻¹² Nm)

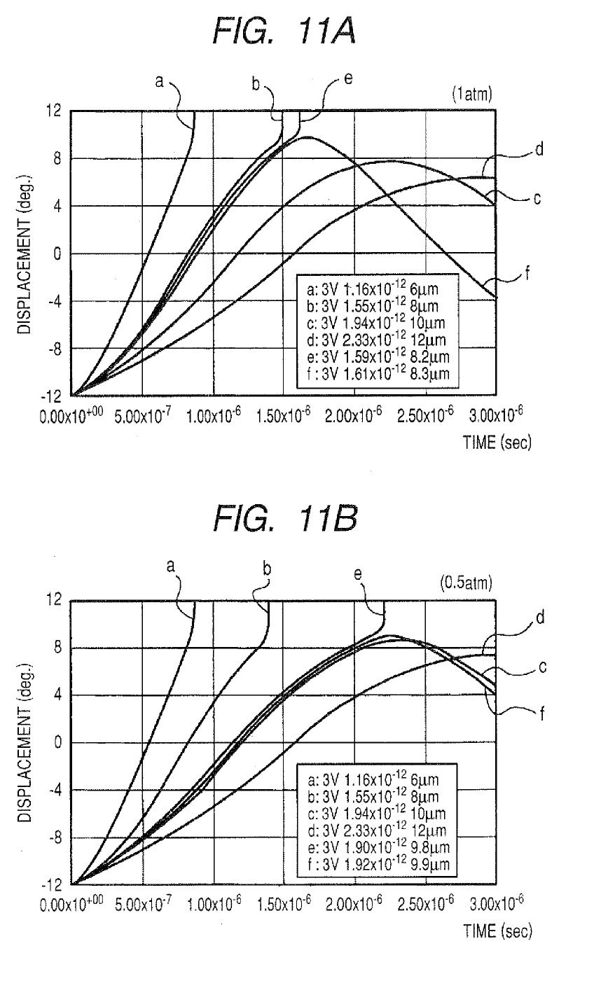

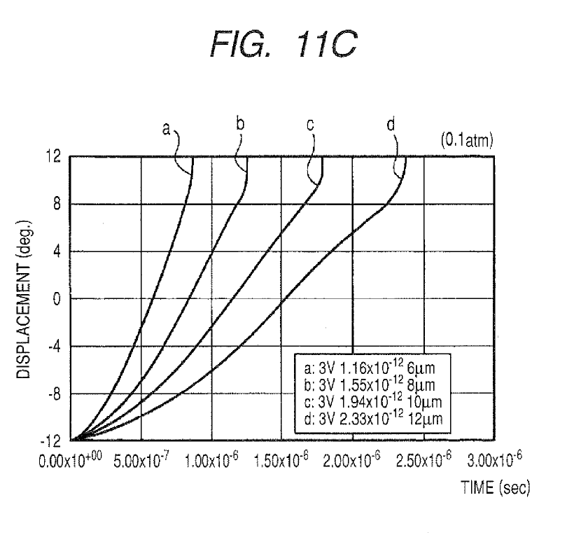

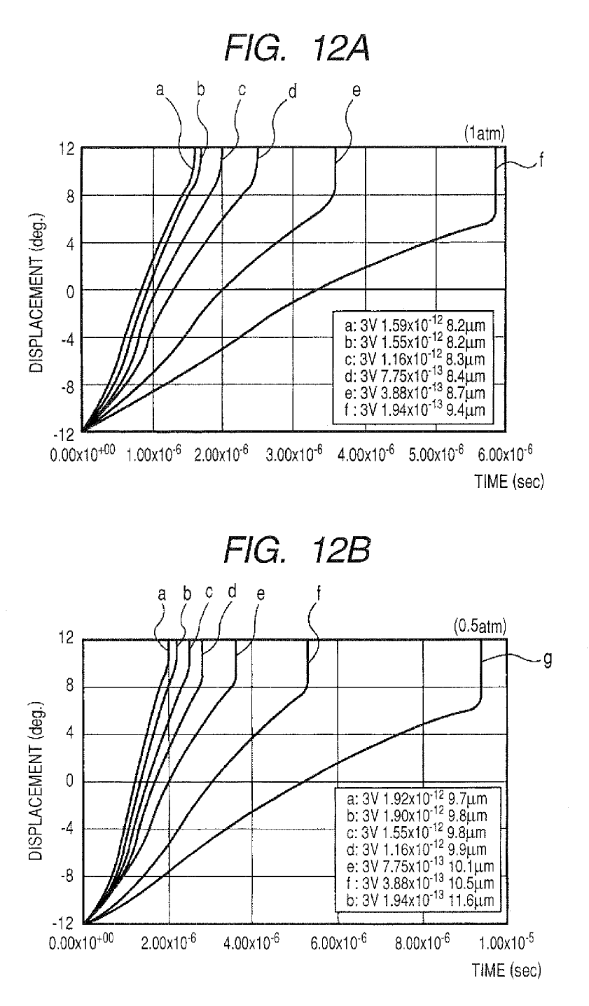

Next, bases for determining the characteristic lines X1, X2, X3, Y1, and Y2 shown in FIGS. 8 and 9 will be shown by using FIGS. 11A to 11C and FIGS. 12A and 12B. FIGS. 11A, 11B, and 11C are diagrams for explaining bases for determining the characteristic lines X1, X2, and X3 shown in FIGS. 8, 9, and 10, respectively. Meanwhile, FIGS. 12A and 12B are diagrams similarly illustrating bases for determining the characteristic lines Y1 and Y2 shown in FIGS. 8 and 9, respectively.

FIGS. 11A to 11C and FIGS. 12A and 12B show whether or not the movable portion was brought into contact with the stop position when samples a to g were prepared under the respective viscosities (the movable portion sizes and supporting portion's elasticity values of the samples differed), and 3 V was applied to the respective samples. Here, the supporting portion's elasticity values were set such that the hold voltage became 3 V in each movable portion size. FIGS. 12A and 12B are also similar, and show whether or not the movable portion was brought into contact with the stop position when 3 V was applied to the structures having the respective movable portion sizes and supporting portion's elasticity values under the respective viscosities.

In FIGS. 11A to 11C and FIGS. 12A and 12B, when similar analysis was carried out by making the movable portion sizes 0.1 μm larger, the movable portions did not come into contact with the lower part. Namely, FIGS. 11A to 11C and FIGS. 12A and 12B show the movable portion sizes and supporting portion's elasticity values at boundaries where the movable portions are brought into contact with the stop position. From the results of these simulations, the respective characteristic lines X1, X2, X3, Y1, and Y2 shown in FIGS. 8, 9, and 10 were determined.

The characteristic lines Y1 and Y2 in this case can be defined as follows.

The characteristic line Y1 (line B) is a line which passes through the following points Qᵢ (L, F) (i is an index of a positive integer):
Q₁=(8.20 μm, 1.59×10⁻¹² Nm)
Q2=(8.20 μm, 1.55×10⁻¹² Nm)
Q₃=(8.30 μm, 1.16×10⁻¹² Nm)
Q₄=(8.40 μm, 7.75×10⁻¹³ Nm)
Q₅=(8.70 μm, 3.88×10⁻¹³ Nm)
Q₆=(9.40 μm, 1.94×10⁻¹³ Nm)

In addition, the characteristic line Y2 (line B) is a line which passes through the following points Qᵢ (L, F) (i is an index of a positive integer):
Q₁=(9.70 μm, 1.92×10⁻¹² Nm)
Q₂=(9.80 μm, 1.90×10⁻¹² Nm)
Q₃=(9.80 μm, 1.55×10⁻¹² Nm)
Q₄=(9.90 μm, 1.16×10⁻¹² Nm)
Q₅=(10.1 μm, 7.75×10⁻¹³ Nm)
Q₆=(10.5 μm, 3.88×10⁻¹³ Nm)
Q₇=(11.6 μm, 1.94×10⁻¹³ Nm)

Here, the characteristic lines Y1 and Y2 (the same also holds true of Y3 to be described later) may be set as a polygonal line connecting the respective points Q, and can also be defined as a smooth curve extending along this polygonal line. For example, the characteristic lines Y1 and Y2 can be defined by a spline curve, a Bezier curve, or the like which passes through the respective points Q. Further, the characteristic lines Y1 and Y2 can also be defined by an approximate curve (e.g., a quadratic curve) such that deviations from the points Q become minimal.

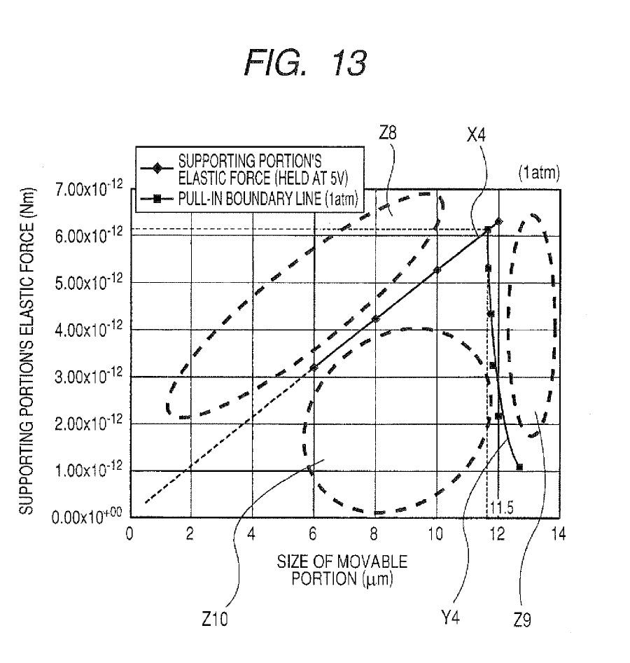

(2) Drive Voltage of 5 V (FIGS. 13 to 16)

Many MEMS element chips are driven at a drive voltage of 3 V or 5 V. Here, analysis was performed by setting such a supporting portion's elastic force that 5 V becomes the hold voltage depending on the size of each movable portion.

FIG. 13 is a characteristic diagram for explaining an appropriate relationship between the size of the movable portion and the elastic force of the supporting portion (hinge) under the conditions of 5 V drive and 1 atmospheric pressure.

First, a limiting point at which the movable portion can be held at the stop position by 5 V was examined. In FIG. 13, the characteristic line X4 shows a limit (boundary) at which the movable portion can be held at the stop position by 5 V. Namely, since a hold voltage higher than 5 V is required in a region Z8 above the characteristic line X4, the region Z8 above the characteristic line X4 falls outside the scope of design. In other words, a region below the characteristic line X4 (Z9+Z10) is the region where the movable portion can be held at the stop position, and it can be said that the scope of design is located in this region.

Further, in FIG. 13, the characteristic line Y4 shows a limit at which the dynamic pull-in is possible by the 5 V drive, and in the region Z9 on the right side of the characteristic line Y4 the movable portion does not undergo a dynamic pull-in, and the movable portion does not reach the stop position even after the lapse of the transition time. The region Z10 on the left side of the characteristic line Y4 is the region where the dynamic pull-in occurs at 5 V, and this region Z10 indicates an appropriate scope of structural design. As is apparent from FIG. 13, 11.5 μm is a boundary point of the size of the movable portion at 1 atmospheric pressure. Accordingly, in a case where the size of the movable portion is not less than 4 μm and less than 11.5 μm, the region where the dynamic pull-in occurs is limited by the characteristic line X4, and in a case where the size of the movable portion is not less than 11.5 μm and less than 12.5 μm, the region is limited by the characteristic line Y4.

Namely, the region Z10 on the lower side of the characteristic line X4 and on the left side of the characteristic line Y4 is the region of the structure in which the movable portion reaches the stop position and is held thereat at 5 V. It therefore suffices if the structure of the micro-electromechanical modulating element is designed so as to be accommodated in this range.

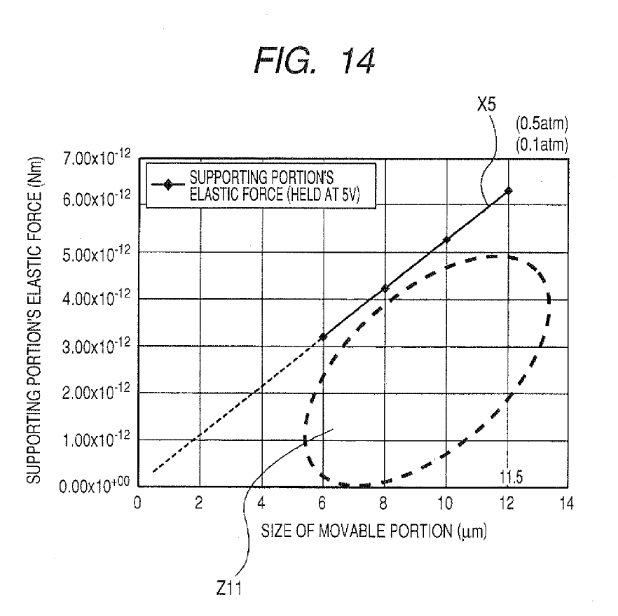

FIG. 14 is a characteristic diagram for explaining an appropriate relationship between the size of the movable portion and the elastic force of the supporting portion (hinge) under the conditions of 5 V drive and 0.5 atmospheric pressure and 0.1 atmospheric pressure.

An approach to viewing FIG. 14 is similar to that of FIG. 13. However, if the atmospheric pressure drops, the viscosity declines, and the movable portion becomes easily rotatable. Therefore, if the range is such that the movable portion can be held at the stop position at 5 V (Z11=Z9+Z10), the dynamic pull-in is also possible, so that the boundary point of the movable size does not exist in FIG. 14.

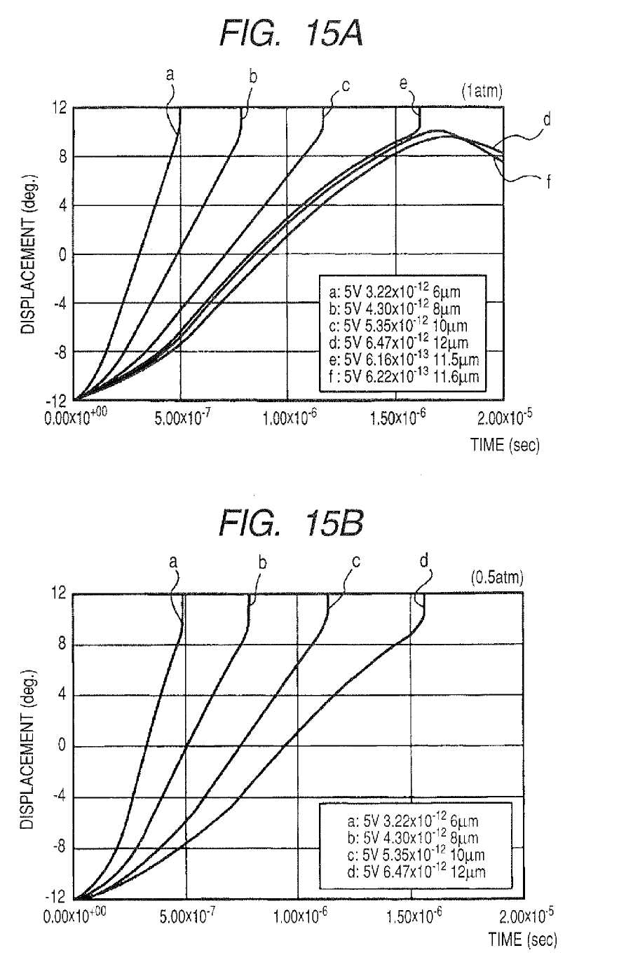

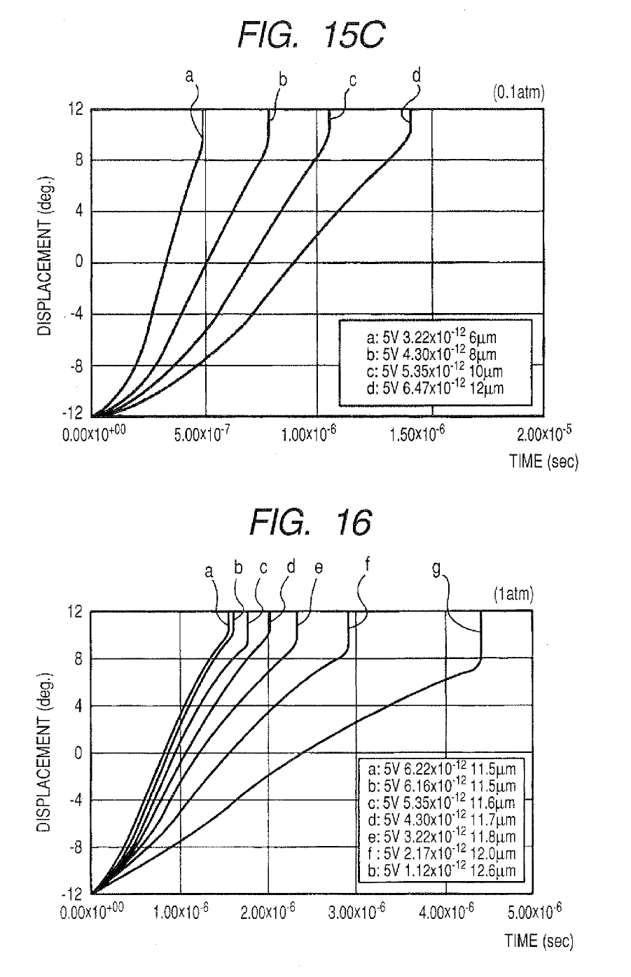

Next, bases for determining the characteristic lines X4, X5, and Y4 shown in FIGS. 13 and 14 will be shown by using FIGS. 15A to 15C and FIG. 16. FIGS. 15A, 15B, and 15C are diagrams for explaining bases for determining the characteristic lines X4 and X5 shown in FIGS. 13 and 14, respectively. Meanwhile, FIG. 16 is a diagram illustrating a basis for determining the characteristic line Y4 shown in FIG. 13.

FIGS. 15A to 11C and FIGS. 16A and 16B show whether or not the movable portion was brought into contact with the stop position when samples a to f were prepared under the respective viscosities (the movable portion sizes and supporting portion's elasticity values of the samples differed), and 5 V was applied to the respective samples. Here, the supporting portion's elasticity values were set such that the hold voltage became 5 V in each movable portion size. FIG. 16A and 12B are also similar, and show whether or not the movable portion was brought into contact with the stop position when 5 V was applied to the structures having the respective movable portion sizes and supporting portion's elasticity values under the respective viscosities.

In FIGS. 15A to 11C and FIGS. 16A and 16B, when similar analysis was carried out by making the movable portion sizes 0.1 μm larger, the movable portions did not come into contact with the lower part. Namely, FIGS. 15A to 11C and FIGS. 16A and 16B show the movable portion sizes and supporting portion's elasticity values at boundaries where the movable portions are brought into contact with the stop position. From the results of these simulations, the respective characteristic lines X4, X5, and Y4 shown in FIGS. 13 and 14 were determined.

The characteristic line X4, Y5, and X4 can be defined as follows.

The characteristic line X4 (line A) is a line which passes through the following points Pᵢ (L, F) (i is an index of a positive integer):
P₁=(6.00 μm, 3.22×10⁻¹² Nm)
P₂=(8.00 μm, 4.30×10⁻¹² Nm)
P₃=(10.0 μm, 5.35×10⁻¹² Nm)
P₄=(11.5 μm, 6.16×10⁻¹² Nm)
P₅=(11.6 μm, 6.22×10⁻¹² Nm)
P₆=(12.0 μm, 6.47×10⁻¹² Nm)

In addition, as for the aforementioned characteristic line X4, the supporting portion's elastic force F and the size L of the movable portion can be expressed by the following relational expression by linear approximation:
F=5.42×10⁻⁷L−3.0×10⁻¹⁴

In addition, the characteristic line Y4 (line B) is a line which passes through the following points Qᵢ (L, F) (i is an index of a positive integer):
Q₁=(11.5 μm, 6.22×10⁻¹² Nm)
Q₂=(11.5 μm, 6.16×10⁻¹² Nm)
Q₃=(11.6 μm, 5.35×10⁻¹² Nm)
Q₄=(11.7 μm, 4.30×10⁻¹² Nm)
Q₅=(11.8 μm, 3.22×10⁻¹² Nm)
Q₆=(12.0 μm, 2.17×10⁻¹² Nm)
Q₇=(12.6 μm, 1.12×10⁻¹² Nm)
The characteristic line X5 in this case can be defined as follows.

The characteristic line X5 (line A) is a line which passes through the following points Pᵢ (L, F) (i is an index of a positive integer):
P₁=(6.00 μm, 3.22×10⁻¹² Nm)
P₂=(8.00 μm, 4.30×10⁻¹² Nm)
P₃=(10.0 μm, 5.35×10⁻¹² Nm)
P₄=(12.0 μm, 6.47×10⁻¹² Nm)
Examples of Analysis

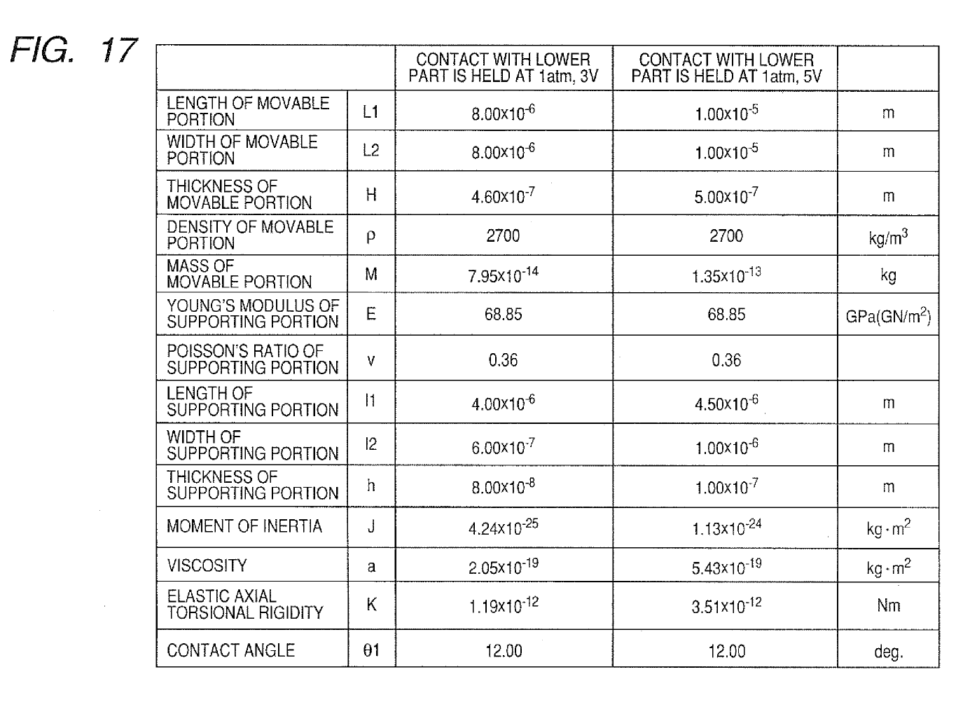

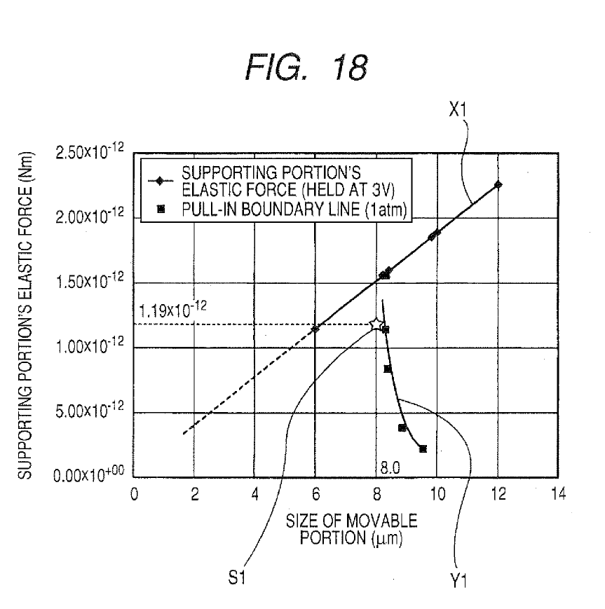

FIG. 17 is a diagram illustrating detailed examples of the structure of the micro-electromechanical modulating element in accordance with the embodiment. In addition, FIG. 18 is a diagram for explaining specific examples of the design of the structure in which, in a case where the micro-electromechanical modulating elements having structures shown in FIGS. 23A and 23B and detailed structures shown in FIG. 17 are driven under 1 atmospheric pressure and at 3 V, the movable portion is brought into contact with the stop position and is held thereat.

In FIG. 18 the characteristic point S1 shows an example of design. It should be noted that aluminum (Al) is assumed to be the material of the supporting portion.

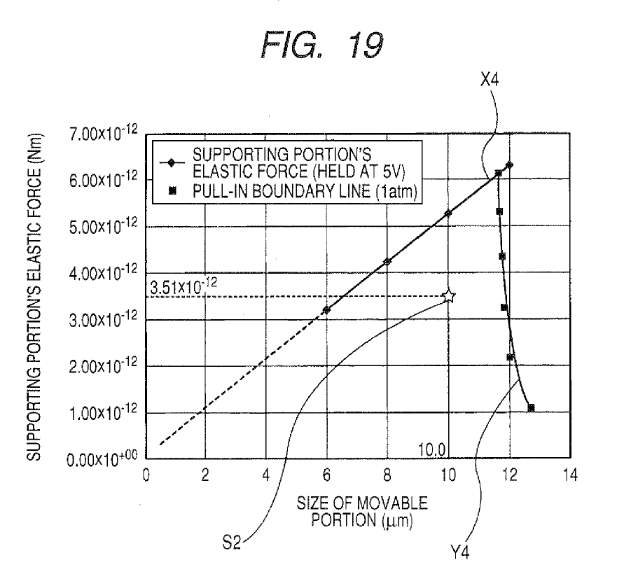

FIG. 19 is a diagram for explaining specific examples of the design of the structure in which, in a case where the micro-electromechanical modulating elements having structures shown in FIGS. 23A and 23B and detailed structures shown in FIG. 17 are driven under 1 atmospheric pressure and at 5 V, the movable portion is brought into contact with the stop position and is held thereat.

In FIG. 19 the characteristic point S2 shows an example of design. It should be noted that aluminum (Al) is assumed to be the material of the supporting portion.

Next, a description will be given of a method of measuring the viscosity data used in the foregoing simulations.

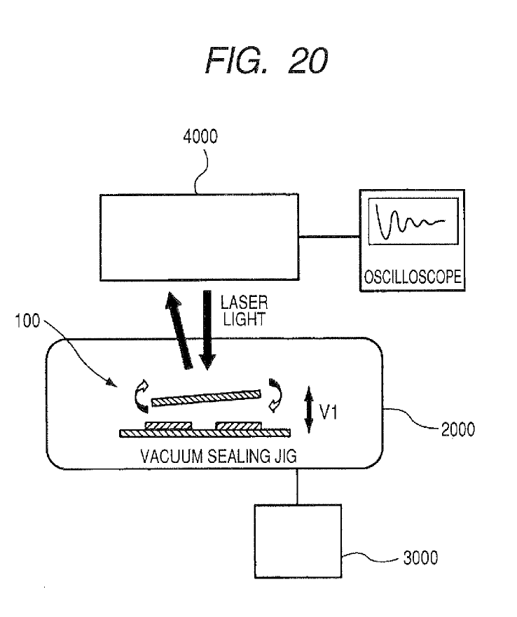

FIG. 20 is a diagram illustrating the configuration of an apparatus for determining a viscous damping coefficient. As shown in the drawing, the micro-electromechanical modulating element 100 is sealed in a vacuum jig 200, and the interior of the vacuum jig 200 is evacuated by a vacuum pump 300 and is held at a predetermined atmospheric pressure. A voltage is then applied across the electrodes on one side of the micro-electromechanical modulating element 100 to tilt the movable portion. If the voltage is subsequently cut off, the movable portion undergoes free vibration, is damped, and becomes stationary at a parallel position. During the damping, laser light is radiated from a rotational displacement measuring apparatus 400 to the movable portion of the micro-electromechanical modulating element 100, and as its reflection is read, a time change of damping is obtained. This measurement was carried out while changing the atmospheric pressure.

(Concerning Viscous Damping Coefficient)

The damping force with respect to a structure can be classified into the following two forms.
(1) External damping or viscous damping (which acts due to the viscosity of such as a fluid surrounding the structure, is proportional to the velocity, and acts from a stationary side)
(2) Internal damping or structural damping (which is due to infinitesimal friction or the like occurring inside the structure, is proportional to strain velocity, and acts due to the internal interaction) The notion that the damping matrix is proportional to a mass [M] or stiffness [K] matrix is called a Rayleigh matrix. If it is now assumed that the damping matrix is [C], and that proportional constants are α and β, the damping matrix can be expressed by Formula (9):
   [C]=α[M]+β[K] (9)

Here, if [C] consists of only the term of α, the damping is called mass proportional damping, and if [C] consists of only the term of β, the damping is called stiffness proportional damping. If this formula is modified, by assuming that ζ is a damping ratio and that ω is a vibrational angular frequency of a structure, Formula (10) is obtained.
ζ=α/2ω+βω/2 (10)

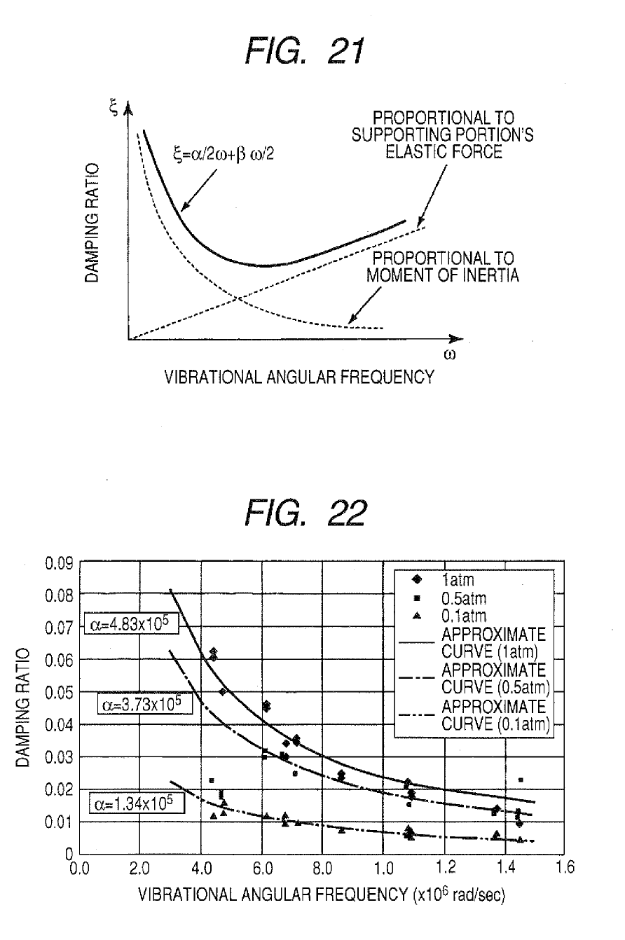

FIG. 21 is a diagram illustrating a relationship between the vibrational angular frequency and the damping ratio. According to Formula (10), in a region where the vibrational angular frequency ω is small, the effect of mass is large, whereas, in a region where ω is large, the effect of stiffness becomes large. (Reference document: “Shindo Moderu to Shimureshon (Vibration Models and Simulation)” (co-authored by Kihachiro Tanaka and Shozo Mitsueda, Sangyo Kagaku Systems)

FIG. 22 is a diagram illustrating changes in the damping ratio with respect to the vibrational angular frequency when rotating system elements having different structures are freely vibrated under respectively different viscous conditions, and a fitting curve is calculated for each viscous condition. This fitting curve is based on only the term of α/2ω in fitting. Since the fitting results are satisfactory, it can be seen that it is appropriate to handle the damping as mass proportional damping in the case of this rotating system element. Accordingly, by using the values of α in the drawing, the behavior of the rotating system element under the respective viscous conditions was used in the simulation analysis. The viscous damping coefficient a can be expressed as in Formula (11):
α=2ζ\sqrt{JK} (11)

It should be noted that, in the aforementioned fitting curve, in the case of 1 atmospheric pressure the viscous damping ratio ζ is included in Formula (12)
ζ=(4.83×10⁵±3.88×10⁴)/2ω (12)

In addition, in the case of 0.5 atmospheric pressure the viscous damping ratio ζ is included in Formula (13):
ζ=(3.79×10⁵±2.86×10⁴)/2ω (13)

In addition, in the case of 0.1 atmospheric pressure the viscous damping ratio ζ is included in Formula (14):
ζ=(1.34×10⁵±1.30×10⁴)/2ω (14)
(Conditions of Analysis)

Next, analysis was conducted on the basis of the above-described method of analysis by using the following variable values and fixed values. The movable portion 15 was assumed to be square, and the size of the hinge serving as the elastically supporting portion was set so as to be determined by the length of the movable portion 15 such that the hinge 17 is concealed underneath the movable portion 15. It was assumed that aluminum was used as the material of the movable portion and the supporting member.

a) Variable Values

Length of movable portion: L₁

Width of movable portion: L₂ (=L₁)

Length of supporting portion: l₁ (=(L₁−2.2 μm)/2)

Width of supporting portion: l₂ (=0 6 μm)

Thickness of supporting portion: h (=0.05 μm)

Mass of movable portion: M

Interelectrode distance: d

Interelectrode potential difference: V

b) Fixed Values

Thickness of movable portion: H=0.5 μm

Density of movable portion: ρ=2.7 g/cm³

Young's modulus of supporting portion: E=68.85 GPa

Poisson's ratio of supporting portion: v=0.36

Angle of contact: θ=10 deg

Coefficient of viscosity: a (set under an environment of 1 atmospheric pressure)

FIGS. 23A and 23B are diagrams illustrating the configuration of a model of the micro-electromechanical modulating element in accordance with the invention, in which FIG. 23A is a plan view, and FIG. 23B is a cross-sectional view taken along line P₁-P₁ of FIG. 23A.

In this structure, the movable portion 15 is integrally formed with a supporting post 25 to which a proximal end side of the hinge 17 is connected, and the other end sides of the hinge 17 are respectively connected to unillustrated hinge fixing portions. As the potential difference V is generated across the first address electrode 21a and the movable portion 15 in a state in which the movable portion 15 is tilted in such a manner as to be located away from the first address electrode 21a, the movable portion 15 is driven to approach the first address electrode 21a, and the transition time of that displacement is calculated.

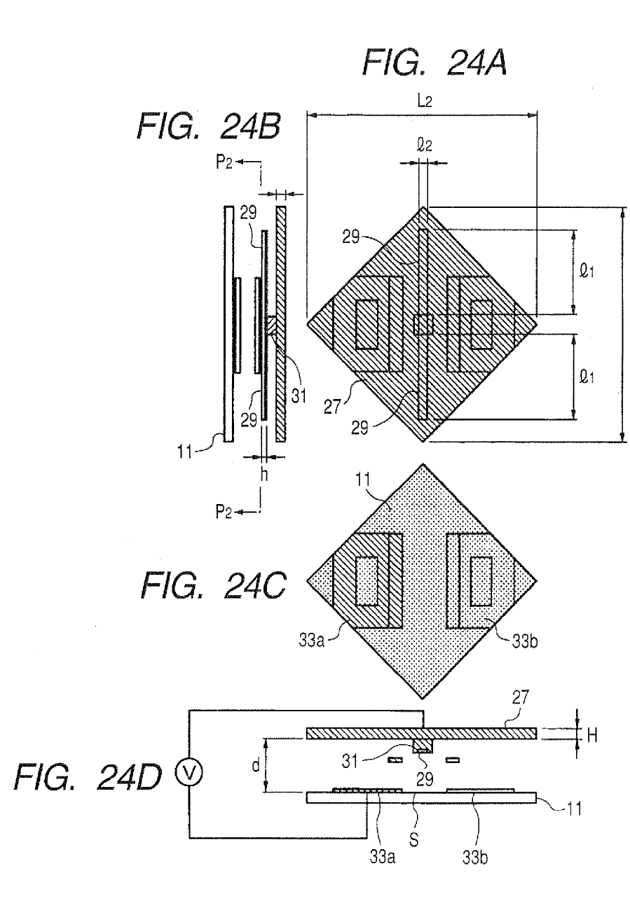

FIGS. 24A to 24D are diagrams illustrating the configuration of a conventional model for comparison with the model of the micro-electromechanical modulating element in accordance with the invention, in which FIG. 24A is a plan view, FIG. 24B is a left side elevational view, FIG. 24C is a plan view as taken in a direction of P2-P2 of FIG. 24B, and FIG. 24D is a lower side elevational view.

In this structure, a movable portion 27 is integrally formed with a supporting post 31 to which a proximal end side of a hinge 29 is connected, and the other end sides of the hinge 29 are respectively connected to unillustrated hinge fixing portions. As the potential difference V is generated across a first address electrode 33a and the movable portion 27 in a state in which the movable portion 27 is attracted onto a second address electrode 33b, the movable portion 27 is driven to approach the first address electrode 33a, and its dynamic behavior was analyzed.

For example, drive at 10 V was attempted with respect to both of micro-electromechanical modulating elements with movable portion sizes of 10.8 μm and 12.6 μm, but the movable portion was not able to pull in to the stop position (final displacement position) even after the lapse of the transition time. Namely, this means that, with the modulating elements of the conventional structures, the movable portion cannot even reach the stop position (final displacement position) at 3 V to 5 V or thereabouts.

From this fact, it can be appreciated that the structure of the MEMS element of the rotating system designed by the design approach based on the dynamic analysis in accordance with the invention is a novel one which can be clearly distinguished from the conventional structures.

### Second Embodiment

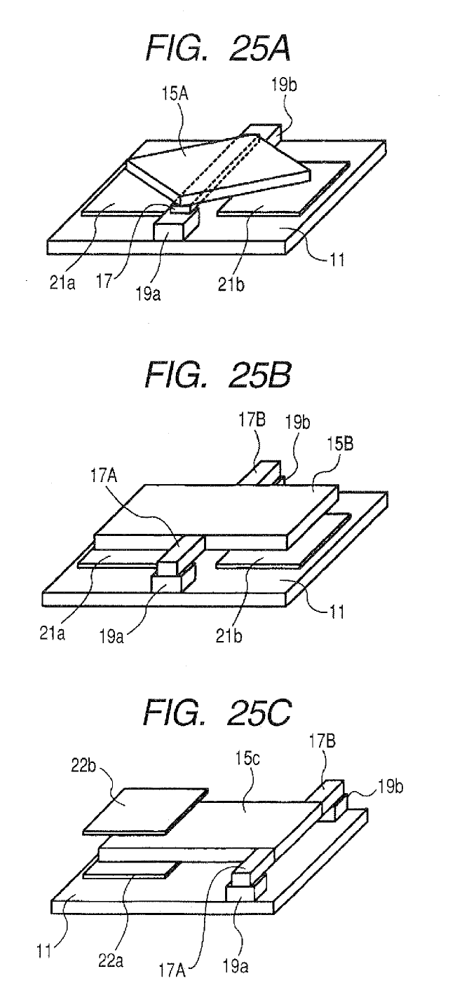

The structure of the micro-electromechanical modulating element is not limited to the one shown in FIG. 1, and may be a different one. FIGS. 25A to 25C respectively show other examples of the configuration of the micro-electromechanical modulating element.

In the micro-electromechanical modulating element shown in FIG. 25A, the hinge 17 is joined to a quadrangular movable portion 25A such that one diagonal line of the movable portion 25A serves as an axis of the rotational motion. Both end portions of the hinge 17 are respectively supported by the pair of spacers 19a and 19b. By virtue of this configuration, a shorter inertial force in the rotational displacement of the movable portion 25A is required, which is advantageous in high-speed drive.

The micro-electromechanical modulating element shown in FIG. 25B has a pair of hinges 17A and 17B respectively extending from both ends of a movable portion 15B, as well as the pair of spacers 19a and 19b for supporting the movable portion 15B over the substrate 11 through the hinges 17A and 17B. By virtue of this configuration, the movable portion 15B can be rotationally displaced by the swinging of the hinges 17A and 17B, while the configuration of the element is simplified.

In the micro-electromechanical modulating element shown in FIG. 25C, one end of a movable portion 15C is supported by and fixed to the substrate 11 by means of the hinges 17A and 17B and the spacers 19a and 19b. Namely, the movable portion 15C is configured in a cantilevered manner with the other end formed as a free end. Further, a first address electrode 22a is provided on the substrate 11 in face-to-face relation to the free end of the movable portion 15C, and a second address electrode 22b formed on an unillustrated opposing substrate is provided on the opposite side of the first address electrode 22a with the movable portion 15C located therebetween. By virtue of this configuration as well, the movable portion 15C can be displaced at high speed at low voltage.

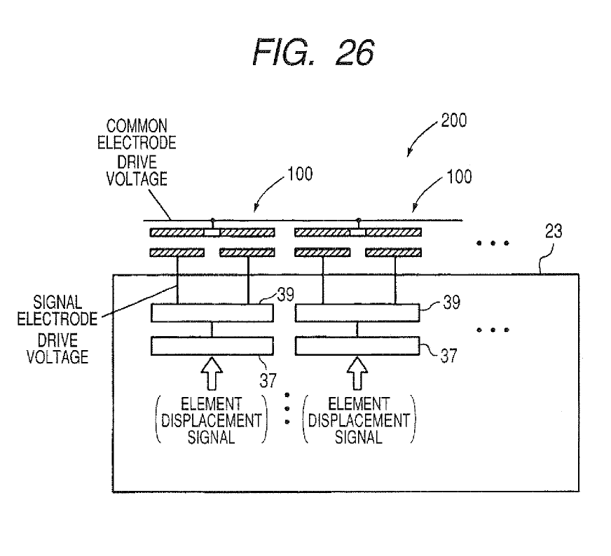

FIG. 26 is an explanatory diagram illustrating a configuration in which each of a plurality of micro-electromechanical modulating elements has a drive circuit including a memory circuit.

As for an micro-electromechanical modulating element array 200, each of the micro-electromechanical modulating elements 100 has the drive circuit 23 (see FIG. 1) including a memory circuit 37. Since such a memory circuit 37 is provided, it becomes possible to write in advance a displacement signal representing an ensuing displacement motion of the element with respect to the memory circuit 37. In other words, an element displacement signal is written in advance in the memory circuit 37, so that when the micro-electromechanical modulating element array 200 is switched, modulation drive is effected by a drive voltage controlling circuit 39 for controlling the voltage to be applied to each micro-electromechanical modulating element 100 on the basis of the element displacement signal stored in the memory circuit 37 of the micro-electromechanical modulating element 100.

Thus, if the micro-electromechanical modulating element 100 is driven by using the memory circuit 37, each of the plurality of elements 100 can be easily operated with an arbitrary drive pattern, and active drive at higher speed becomes possible. It should be noted that although the configuration of the micro-electromechanical modulating element 100 of FIG. 1 is shown here, the micro-electromechanical modulating element is not limited to the same, and an element of other configuration may be used.

Next, a description will be given of an image forming apparatus configured by using the above-described micro-electromechanical modulating elements 100. Here, a description will first be given of an exposing apparatus 300 as an example of the image forming apparatus.

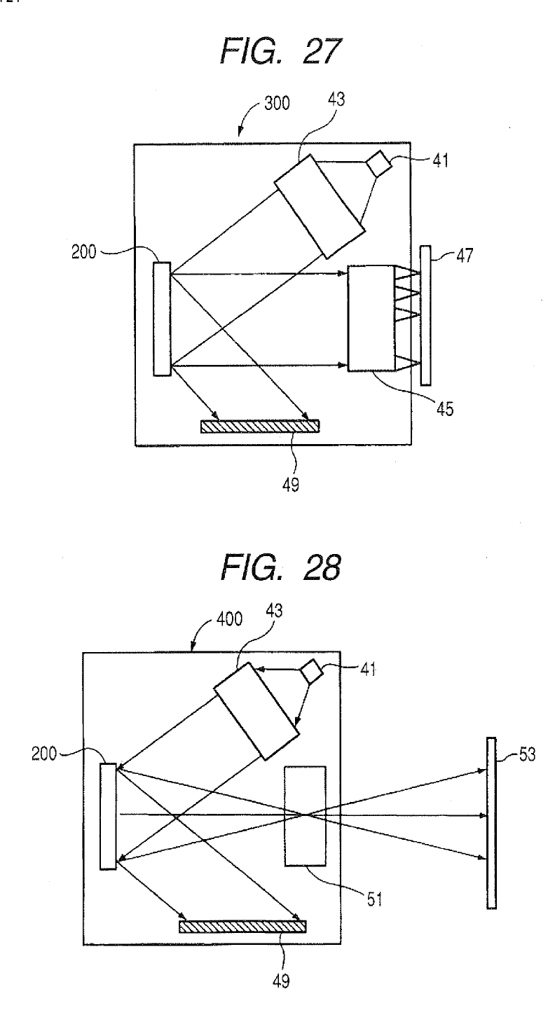

FIG. 27 is a diagram illustrating a schematic configuration of the exposing apparatus constructed by using the micro-electromechanical modulating element array in accordance with the invention. The exposing apparatus 300 is comprised of an illuminating light source 41; an illuminating optical system 43; the micro-electromechanical modulating element array 200 in which the plurality of micro-electromechanical modulating elements 100 in accordance with the above-described embodiment are arrayed flush with each other two-dimensionally; and a projecting optical system 45.

The illuminating light source 41 is a light source such as a laser, a high-pressure mercury lamp, a short arc lamp, or the like. The illuminating optical system 43 is, for example, a collimator lens for converting planar light emitted from the illuminating light source 41 into parallel light. The parallel light transmitted through the collimator lens is incident upon each micro-electromechanical modulating element 100 of the micro-electromechanical modulating element array 200. The means for converting the planar light emitted from the illuminating light source 41 into parallel light includes, in addition to the collimator lens, such as a method in which two microlenses are arranged in series. In addition, as the illuminating light source 41, by using a light source, such as a short arc lamp, whose luminous point is small, the illuminating light source 41 may be regarded as a point light source, and parallel light may be made incident upon the micro-electromechanical modulating element array 200. Furthermore, an LED array having LEDs corresponding to the respective micro-electromechanical modulating elements 100 of the micro-electromechanical modulating element array 200 may be used as the illuminating light source 41, and light may be emitted by locating the LED array and the micro-electromechanical modulating element array 200 into close proximity to each other, thereby allowing parallel light to be incident upon the micro-electromechanical modulating elements 100 of the micro-electromechanical modulating element array 200. It should be noted that in the case where a laser is used as the illuminating light source 41, the illuminating optical system 43 may be omitted.

The projecting optical system 45 is for projecting light onto a recording medium 47, i.e., an image forming surface, and is, for example, a microlens array having microlenses corresponding to the micro-electromechanical modulating elements 100 of the micro-electromechanical modulating element array 200.

Hereafter, a description will be given of the operation of the exposing apparatus 300.

The planar light emitted from the illuminating light source 41 is incident upon the illuminating optical system 43, and the light converted thereby into parallel light is incident upon the micro-electromechanical modulating element array 200. The light incident upon the micro-electromechanical modulating elements 100 of the micro-electromechanical modulating element 200 is controlled so as to be reflected in accordance with an image signal. The light emergent from the micro-electromechanical modulating element array 200 is imaged and exposed on an image forming surface of the recording medium 47 by the projecting optical system 45. The imaging light is projected and exposed onto the recording medium 47 while being relatively moved in a scanning direction, and is able to expose a wide area with high resolution. As the collimator lens is thus provided on the light incident plane side of the micro-electromechanical modulating element array 200, the light incident upon the planar substrate of each modulating element can be converted into parallel light. It should be noted that, in the drawing, reference numeral 49 denotes a light absorber for introducing off light.

The exposing apparatus 300 can be formed not only by using the collimating lens as the illuminating optical system 133 but by using a microlens array. In this case, the respective microlenses of the microlens array correspond to the respective micro-electromechanical modulating elements 100 of the micro-electromechanical modulating element array 200, and are designed and adjusted such that optical axes and focal planes of the microlenses are aligned with centers of the respective light modulating elements.

In this case, incident light from the illuminating light source 41 is focused onto a region having an area smaller than one element of the micro-electromechanical modulating element 100 and is incident upon the micro-electromechanical modulating element array 200 by the microlens array. The light incident upon each of the micro-electromechanical modulating elements 100 of the micro-electromechanical modulating element array 200 is controlled to be reflected in accordance with the inputted image signal. The light emitted from the micro-electromechanical modulating element array 200 is projected to be exposed onto the image forming surface of the recording medium 47 by the projecting optical system 45. The projected light is projected to be exposed onto the recording medium 47 while being relatively moved in the scanning direction, and is able to expose a wide area by high resolution. In this way, the light from the illuminating light source 41 can be focused by the microlens array, and therefore it is possible to realize an exposing apparatus whose light utilizing efficiency is improved.

Further, the shape of the lens surface of the microlens is not particularly limited and may be a spherical surface, a semispherical surface, or the like, and may be a convex curved surface or a concave curved surface. In addition, the microlens array may be a microlens array with a flat shape having a refractive index distribution, and may be arrayed with a Fresnel lens or a diffractive type lens by binary optics or the like. A material of the microlens is constituted by, for example, transparent glass or resin. From the viewpoint of mass productivity, resin is excellent, and from the viewpoint of service life and reliability, glass is excellent. From an optical viewpoint, quartz glass, molten silica, alkali-free glass, or the like is preferable as glass, and an acrylic base, an epoxy base, a polyester base, a polycarbonate base, a styrene base, a vinyl chloride base, or the like is preferable as resin. It should be noted that, as resin, there is a photo-curing type, a thermoplastic type, or the like, which is preferably selected appropriately in accordance with a method of fabricating microlenses.

Next, a description will be given of a projecting apparatus as another example of the image forming apparatus.

FIG. 28 is a diagram illustrating a schematic configuration of a projecting apparatus constructed by using the micro-electromechanical modulating element array in accordance with the invention. Arrangements similar to those of FIG. 18 are denoted by the same reference numerals, and a description thereof will be omitted.

A projector 400 as a projecting apparatus is comprised of the illuminating light source 41, the illuminating optical system 43, the micro-electromechanical modulating element array 200, and a projecting optical system 51. The projecting optical system 51 is an optical system for a projecting apparatus for projecting light onto a screen 53 constituting the image forming surface. The illuminating optical system 43 may be the aforementioned collimator lens or may be a microlens array.

Next, a description will be given of the operation of the projector 400.

Emergent light from the illuminating light source 41 is focused onto a region having an area smaller than that of one element of the micro-electromechanical modulating element 100 by, for example, a microlens array and is incident upon the micro-electromechanical modulating element array 200. The light incident upon each of the micro-electromechanical modulating elements 100 of the micro-electromechanical modulating element array 200 is controlled to be reflected in accordance with the image signal. The light emitted from the micro-electromechanical modulating element array 200 is projected to be exposed onto the image forming surface of the screen 53 of the projecting optical system 51. In this way, the micro-electromechanical modulating element array 200 can be utilized for the projecting apparatus as well, and is also applicable to a display apparatus.

Therefore, in the image forming apparatus of the exposing apparatus 300, the projector 400, or the like, as the micro-electromechanical modulating element array 200 is provided as an essential portion of the configuration, a low-voltage, high-speed displacement of the movable portion 15 becomes possible. As a result, a high-speed photosensitive material exposure and a display of a projector having a greater number of pixels become possible. Further, in the image forming apparatus (exposing apparatus 300) in which gradation control is provided by the turning on and off of exposing light, a higher gradation can be realized by enabling to shorten the on/off time. As a result, a photosensitive material can be exposed at high speed, or display can be carried out by a projector having a greater number of pixels.

As described above, according to the invention, it becomes possible to analyze the relationship between the size of the movable portion of the micro-electromechanical modulating element of a rotating system and the elastic force of the elastically supporting portion, including the effect of viscosity due to the ambient air, and clarify the dynamic behavior of the movable portion. On the basis of its knowledge, it becomes possible to reliably and easily realize a structure whereby the movable portion can be appropriately displaced and held at the final displacement position at a low voltage (e.g., 10 V or less).

The invention is useful in application to the structure of a micro-electromechanical modulating element of a rotating system which is driveable at a low voltage and rotates bidirectionally, as well as dynamic analysis and condition setting including the viscous effect for driving the modulating element at a low voltage, a micro-electromechanical modulating element array, and an image forming apparatus.

This application is based on Japanese Patent application JP 2006-103359, filed Apr. 4, 2006, the entire content of which is hereby incorporated by reference, the same as if set forth at length.

What is claimed is:

1. A micro-electromechanical modulating element comprising:
a plurality of movable portions each supported on a fixed substrate elastically displaceably and adapted to be rotationally displaced bidirectionally, each of the movable portions having a modulating function;
a plurality of driving portions each adapted to apply a physical acting force to the movable portion on application of a voltage thereto,
wherein, by means of the physical acting force from the driving portion, the movable portion is capable of reaching a first stop position where the movable portion is brought into contact with and stops on a side of the fixed substrate after being rotationally displaced in a first direction and of reaching a second stop position where the movable portion is brought into contact with and stops on the side of the fixed substrate after being rotationally displaced in a second direction different from the first direction,
wherein a dynamic pull-in voltage is set to be lower than a hold voltage, and the driving portion drives the movable portion by a drive voltage greater than or equal to the hold voltage and the drive voltage is less than or equal to 10 V, in which the hold voltage is a voltage capable of holding a state of the movable portion at each of the first and second stop positions as it is, and the dynamic pull-in voltage is a voltage capable of pulling in the movable portion in a state of being not located at each of the first and second stop positions to each of the first and second stop positions over a transition time.

2. The micro-electromechanical modulating element according to claim 1, wherein the movable portion is supported on the fixed substrate by means of an elastically supporting portion, and in a case a relationship of an elastic force of the elastically supporting portion with respect to a size of the movable portion is plotted into a graph, by using as boundaries a line A indicating a limit of the elastic force of the elastically supporting portion with respect to such a size of the movable portion as to allow the movable portion to be held at each of the first and second stop positions upon application of a predetermined drive voltage to the movable portion, and a line B indicating a limit of the elastic force of the elastically supporting portion with respect to such a size of the movable portion as to allow the movable portion to be pulled in to each of the first and second stop positions over the transition time when the movable portion is driven at the predetermined drive voltage, the elastic force of the elastically supporting portion with respect to the size of the movable portion is defined so as to be included in a region on a side of the line A where the elastic force of the elastically supporting portion becomes low and in a region on a side of the line B where the size of the movable portion becomes small.

3. The micro-electromechanical modulating element according to claim 2, wherein the predetermined drive voltage is a voltage of 5 V.

4. The micro-electromechanical modulating element according to claim 2, wherein in a case where an ambient pressure of the movable portion is an atmospheric pressure, the line A is a line which passes through following points Pᵢ (L, F) in which i is an index of a positive integer, and the line B is a line which passes through following points Qᵢ (L, F) in which i is an index of a positive integer, wherein L is the size of the movable portion and F is the supporting portion's elastic force:
P₁=(6.00 μm, 3.22×10⁻¹² Nm)
P₂=(8.00 μm, 4.30×10⁻¹² Nm)
P₃=(10.0 μm, 5.35×10⁻¹² Nm)
P₄=(11.5 μm, 6.16×10⁻¹² Nm)
P₅=(11.6 μm, 6.22×10⁻¹² Nm)
P₆=(12.0 μm, 6.47×10⁻¹² Nm)
Q₁=(11.5 μm, 6.22×10⁻¹² Nm)
Q₂=(11.5 μm, 6.16×10⁻¹² Nm)
Q₃=(11.6 μm, 5.35×10⁻¹² Nm)
Q₄=(11.7 μm, 4.30×10⁻¹² Nm)
Q₅=(11.8 μm, 3.22×10⁻¹² Nm)
Q₆=(12.0 μm, 2.17×10⁻¹² Nm)
Q₇=(12.6 μm, 1.12×10⁻¹² Nm)

5. The micro-electromechanical modulating element according to claim 2, wherein in a case where an ambient pressure of the movable portion is approximately 0.5 atmospheric pressure, the line A is a line which passes through following points Pᵢ (L, F) in which i is an index of a positive integer, L is the size of the movable portion and F is the supporting portion's elastic force :
P₁=(6.00 μm, 3.22×10⁻¹² Nm)
P₂=(8.00 μm, 4.30×10⁻¹² Nm)
P₃=(10.0 μm, 5.35×10⁻¹² Nm)
P₄=(12.0 μm, 6.47×10⁻¹² Nm)

6. The micro-electromechanical modulating element according to claim 2, wherein the predetermined drive voltage is a voltage of 3 V.

7. The micro-electromechanical modulating element according to claim 6, wherein in a case where an ambient pressure of the movable portion is an atmospheric pressure, the line A is a line which passes through following points Pᵢ (L, F) in which i is an index of a positive integer, and the line B is a line which passes through following points Qᵢ (L, F) in which i is an index of a positive integer, wherein L is the size of the movable portion and F is the supporting portion's elastic force:
P₁=(6.00 μm, 1.16×10⁻¹² Nm)
P₂=(8.00 μm, 1.55×10⁻¹² Nm)
P₃=(8.20 μm, 1.59×10⁻¹² Nm)
P₄=(8.30 μm, 1.61×10⁻¹² Nm)
P₅=(10.0 μm, 1.94×10⁻¹² Nm)
P₆=(12.0 μm, 2.33×10⁻¹² Nm)
Q₁=(8.20 μm, 1.59×10⁻¹² Nm)
Q₂=(8.20 μm, 1.55×10⁻¹² Nm)
Q₃=(8.30 μm, 1.16×10⁻¹² Nm)
Q₄=(8.40 μm, 7.75×10⁻¹³ Nm)
Q₅=(8.70 μm, 3.88×10⁻¹³ Nm)
Q₆=( 9.40 μm, 1.94×10⁻¹³ Nm)

8. The micro-electromechanical modulating element according to claim 2, wherein in a case where an ambient pressure of the movable portion is approximately 0.5 atmospheric pressure, the line A is a line which passes through following points Pᵢ (L, F) in which i is an index of a positive integer, and the line B is a line which passes through following points Qᵢ (L, F) in which i is an index of a positive integer, wherein L is the size of the movable portion and F is the supporting portion's elastic force:
P₁=(6.00 μm, 1.16×10⁻¹² Nm)
P₂=(8.00 μm, 1.55×10⁻¹² Nm)
P₃=(9.80 μm, 1.90×10⁻¹² Nm)
P₄=(9.90 μm, 1.92×10⁻¹² Nm)
P₅=(10.0 μm, 1.94×10⁻¹² Nm)
P₆=(12.0 μm, 2.33×10⁻¹² Nm)
Q₁=(9.70 μm, 1.92×10⁻¹² Nm)
Q₂=(9.80 μm, 1.90×10⁻¹² Nm)
Q₃=(9.80 μm, 1.55×10⁻¹² Nm)
Q₄=(9.90 μm, 1.16×10⁻¹² Nm)
Q₅=(10.1 μm, 7.75×10⁻¹³ Nm)
Q₆=(10.5 μm, 3.88×10⁻¹³ Nm)
Q₇=(11.6 μm, 1.94×10⁻¹³ Nm)

9. The micro-electromechanical modulating element according to claim 2, wherein in a case where an ambient pressure of the movable portion is approximately 0.1 atmospheric pressure, and the size of the movable portion is from 4 μm to 11.5 μm, the line A is a line which passes through following points Pᵢ (L, F) in which i is an index of a positive integer, L is the size of the movable portion and F is the supporting portion's elastic force:
P₁=(6.00 μm, 1.16×10⁻¹² Nm)
P₂=(8.00 μm, 1.55×10⁻¹² Nm)
P₃=(10.0 μm, 1.94×10⁻¹² Nm)
P₄=(12.0 μm, 2.33×10⁻¹² Nm)

10. The micro-electromechanical modulating element according to claim 1, wherein behavior of the movable portion on application of the drive voltage thereto is one in which a viscous damping ratio ζ of the movable portion satisfies a following formula:
ζ=(4.83×10⁵±3.88×10⁴)/2ω
wherein ω is a vibrational angular frequency.

11. The micro-electromechanical modulating element according to claim 1, wherein behavior of the movable portion on application of the drive voltage thereto is one in which a viscous damping ratio ζ of the movable portion satisfies a following formula:
ζ=(3.79×10⁵±2.86×10⁴)/2ω
wherein ω is a vibrational angular frequency.

12. The micro-electromechanical modulating element according to claim 1, wherein behavior of the movable portion on application of the drive voltage thereto is one in which a viscous damping ratio ζ of the movable portion satisfies a following formula:
ζ=(1.34×10⁵±1.30×10⁴)/2ω
wherein ω is a vibrational angular frequency.

13. The micro-electromechanical modulating element according to claim 1, wherein the movable portion is brought into contact with a stopper member disposed at a respective final displacement position and stops thereat.

14. The micro-electromechanical modulating element according to claim 1, wherein the physical acting force is applied to a plurality of points of application of the movable portion.

15. The micro-electromechanical modulating element according to claim 1, wherein the physical acting force for displacing the movable portion in the first direction and the second direction by the driving portion is an electrostatic force.

16. The micro-electromechanical modulating element according to claim 1, wherein a planar shape of the movable portion is quadrangular.

17. The micro-electromechanical modulating element according to claim 1, wherein a waveform of the physical acting force for rotationally displacing the movable portion includes at least one of a rectangular wave, a sine wave, a cosine wave, a sawtooth wave, and a triangular wave.

18. The micro-electromechanical modulating element according to claim 1, wherein the elastically supporting portion for supporting the movable portion elastically displaceably is formed from a polymeric material.

19. The micro-electromechanical modulating element according to claim 1, wherein the elastically supporting portion for supporting the movable portion elastically displaceably is formed from at least one of a metal material, a resin material, and a hybrid material thereof.

20. The micro-electromechanical modulating element according to claim 1, further comprising a control portion for controlling the modulating operation by driving the movable portion.

21. A micro-electromechanical modulating element array comprising the micro-electromechanical modulating elements according to claim 1 arrayed one-dimensionally or two-dimensionally.

22. The micro-electromechanical modulating element array according to claim 21, wherein each of the micro-electromechanical modulating elements has a drive circuit including a memory circuit, and one of electrodes which are provided on the movable portion and on at least two or more fixed portions opposing the movable portion is a signal electrode to which an element displacement signal from the drive circuit is inputted, while another one thereof is a common electrode.

23. An image forming apparatus comprising:
a light source;
the micro-electromechanical modulating element array according to claim 21;
an illuminating optical system for radiating light from the light source onto the micro-electromechanical modulating element array; and
a projecting optical system for projecting the light emergent from the micro-electromechanical modulating element array onto an image forming plane.

24. A method for designing a micro-electromechanical modulating element which includes an elastically supporting portion and a movable portion supported by the elastically supporting portion, and is driveable at a low voltage, the method comprising:
obtaining a characteristic line A by plotting, on a plane indicating a relationship of an elastic force of the elastically supporting portion with respect to a size of the movable portion, a limiting point at which the movable portion can be held at a final displacement position by a desired voltage;
obtaining a characteristic line B by plotting on the plane a limiting point at which the movable portion can be pulled in to the final displacement position over a transition time in a case where the movable portion is driven at the desired voltage; and
determining the elastic force of the elastically supporting portion with respect to the size of the movable portion so as to be included in a region on a side where the elastic force of the elastically supporting portion becomes low by using the line A as a boundary and in a region on a side where the size of the movable portion becomes small by using the line B as a boundary.

25. The method according to claim 24, wherein at the time of analyzing the behavior of the movable portion through application of the drive voltage thereto, a viscous damping ratio ζ of the movable portion is determined by a following formula by regarding the damping as mass proportional damping in which the viscous damping ratio is proportional to mass:
ζ∝α/2ω
wherein α is a viscous damping constant, and ω is a vibrational angular frequency.
